(19) United States
(12) Patent Application Publication
(10) Pub. No.: US 2017/0206575 A1
(43) Pub. Date: Jul. 20, 2017

(54) Skill Sharing Platform

(71) Applicant: Micah Shankle, Denver, CO (US)

(72) Inventor: Micah Shankle, Denver, CO (US)

(21) Appl. No.: 15/407,057

(22) Filed: Jan. 16, 2017

Related U.S. Application Data
(60) Provisional application No. 62/280,204, filed on Jan. 19, 2016.

(51) Int. Cl. G06Q 30/06; G06F 17/30; G06Q 30/02

(52) U.S. Cl. CPC G06Q 30/0611; G06Q 30/0282; G06F 17/3087

(57) ABSTRACT

A skill sharing platform is disclosed. In an example, the skill sharing platform includes a computer store including data defining a plurality of skill profiles. Each of the skill profiles corresponds to a service provider offering services. Each of the skill profiles corresponds to defined geospatial service areas. The skill sharing platform may also include a computer server coupled to the computer store. The computer server is programmed to receive a request from a consumer; identify a requested skill profile based on input received from a consumer in the request; provide the requested skill profile to the consumer using the skill sharing platform in a defined geospatial service area; and determine at least one of a score and a karma based on interaction between the service provider and the consumer. The score and the karma may influence other consumers' decisions to generate a request for services.

### PRIORITY CLAIM

This application claims the priority benefit of U.S. Provisional Patent Application No. 62/280,204 filed Jan. 19, 2016 titled “Skill Sharing Platform” of Micah Shankle, hereby incorporated by reference for everything disclosed therein as though fully set forth herein.

### BACKGROUND

Providers often need to make their skills available to others for scheduled engagements within user-defined geospatial service areas. Consumers often need to find, contact, and schedule reputable people with specific skills for scheduled engagements.

Service Providers may advertise en-masse (e.g., newspapers, television, commercials, take journals), or online (e.g., Yelp® or other service-oriented sites). Consumers either ask others (e.g., friends, co-workers) for recommendations, happen to find a service provider in an advertisement, or search online. These methods provide marketing to a region or city and do not allow granular control over the area a provider may service. As such, appropriate matches between a quality service provider and a consumer are usually happenstance. These engagements also usually require the exchange of personal information (e.g., phone number, email) to facilitate verifying the provider services the location in question, negotiating a schedule for the engagement, form and amount of payment, or other communication. With this personal information in hand, people can be contacted outside of normal operating hours, by others the information was shared with, or with entities for marking purposes.

### BRIEF DESCRIPTION OF THE DRAWINGS

FIG. 1 depicts an example hardware architecture implementing the skill sharing platform.

FIG. 2 illustrates the software architecture of an example Web server layer implementing the skill sharing platform.

FIG. 3 illustrates the software architecture of an example application server layer implementing the skill sharing platform.

FIG. 4 is a flow chart of the pages and procedure in the request creation process.

FIG. 5 is a flow chart of the pages and procedure in the account management process.

FIG. 6 is a flow chart of the pages and procedure in a consumers request lifecycle.

FIG. 7 is a flow chart of the pages and procedure in a providers request lifecycle.

FIG. 8 is a flow chart of the page and procedure in the guild master and member process.

FIG. 9 is a screen capture of the application home page in a preferred embodiment.

FIG. 10 is a screen capture of the application home page in a preferred embodiment after a user enters a search term.

FIG. 11 is a screen capture of the search results page in a preferred embodiment.

FIG. 12 is a screen capture of the profile page profile tab in a preferred embodiment.

FIG. 13 is a screen capture of the profile page skills tab in a preferred embodiment.

FIG. 14 is a screen capture of the profile page reviews tab in a preferred embodiment.

FIG. 15 is a screen capture of the account login page in a preferred embodiment.

FIG. 16 is a screen capture of a logged in user viewing their own profile page profile tab in a preferred embodiment.

FIG. 17 is a screen capture of a logged in user viewing the own profile page skills tab in a preferred embodiment.

FIG. 18 is a screen capture of the skill page in a preferred embodiment when a user adds a skill to their profile.

FIG. 19 is a screen capture of the create request page in a preferred embodiment.

FIG. 20 is a screen capture of the inbox tab in a preferred embodiment.

FIG. 21 is a screen capture of the requested detail page in a preferred embodiment.

FIG. 22 is a screen capture of the outbox tab in a preferred embodiment.

FIG. 23 is a screen capture of the request detail page in a preferred embodiment before the requesting user confirms a service provider.

FIG. 24 is a screen capture of the chat page in a preferred embodiment.

FIG. 25 is a screen capture of the request detail page in a preferred embodiment when the service provider has been confirmed.

FIG. 26 is a screen capture of the close request page in a preferred embodiment when a consumer is closing a request and reviewing the service provider.

FIG. 27 is a screen capture of the close request page in a preferred embodiment when the provider is closing a request and reviewing the consumer.

FIG. 28 is a screen capture of the block list page in a preferred embodiment.

FIG. 29 is a screen capture of the guild page in a preferred embodiment when not associated with a guild.

FIG. 30 is a screen capture of the guild page in a preferred embodiment as a guild master.

FIG. 31 is a screen capture of the guild page in a preferred embodiment as a guild member.

FIG. 32 is a screen capture of the guild profile page profile tab in a preferred embodiment as a guild master.

FIG. 33 is a screen capture of the guild profile page skills tab in a preferred embodiment as a guild master.

FIG. 34 is a screen capture of the join guild page in a preferred embodiment.

FIG. 35 is a screen capture of the skill page in a preferred embodiment when a user is a member of a guild.

FIG. 36 is a flow chart of the procedure and status associated with a typical non-bid request.

FIG. 37 is a flow chart of the procedure and status associated with a typical bid request. Depending on events that transpire, the flow may transfer back to FIG. 36.

### DETAILED DESCRIPTION

A skill sharing platform and method is disclosed herein for service providers to make their skills available to consumers in scheduled engagements within the service providers defined geospatial service area. In an example, the platform enables a user (e.g., a service provider) to generate skill profile and make that skill profile available upon request to users of the skill sharing platform (e.g., consumers) in a defined geospatial service area. A user's decision whether to generate a request for, or accept a request from another user, is guided by the “score” and “karma” of the respective user(s).

As used herein, the term “score” means a user's proficiency in a skill. In an example, the term “score” is a value of 0 thru 100, the number signifying a user's proficiency in a specific skill. This number is an average of all ratings submitted at the completion of a request rounded to the nearest whole number.

As used herein, the term “karma” means a user's rating as a person. In an example, the term “karma” is a number of 0 thru 5, signifying a user's rating as a person, including but not limited to, personality traits, communication ability, professional appearance, work ethic, and timeliness. This number is an average of all ratings submitted at the completion of a request rounded to the nearest whole number.

It is noted that the terms “service provider” and “consumer” refer to a user. The term “platform” refers to hardware and/or software for interaction by a user. A user becomes a “service provider” by creating a skill profile for providing services on the platform. A user becomes a consumer by searching the platform for a service provider. A user can be both a service provider and a consume simultaneously.

An example operating environment may include a data store, a server, and a communication link to a user device. The server performs the task of validating the skill profile entered by a user device, storing the profile in the data store, and displaying that profile to a user device. The server also performs the task of notifying a user device when certain conditions are met. The Internet serves as the communication link to a user device.

In an example, the skill sharing platform enables a user to attach one or multiple providers to a skill request. In the case of multiple providers, each provider has the option to bid against other providers for acceptance of the request.

In an example, one or more request parameters (e.g., date, time, rate) may be negotiable. In addition, when a user modifies an existing request, all associated users may be notified of the change. In an example, one or more request parameter (e.g., rate) may not be modified after a request has been confirmed or accepted by the user making the request.

Upon completion of a request, the skill sharing platform may require a user to rate their experience. These ratings may be used to generate the score and karma of the other user. In an example, if a provider's score and/or karma fall below a threshold, the provider may be penalized. For example, the provider may be blocked from the user making the request for all future requests. The block list may be editable for the user making the request, e.g., to reinstate a provider. In addition, the user may issue the block list to another user (e.g., a friend or family member).

It is noted that other algorithms may also be used to determine score and karma. In addition, as used herein, the terms “includes” and “including” mean, but is not limited to, “includes” or “including” and “includes at least” or “including at least.” The term “based on” means “based on” and “based at least in part on.”

Before continuing, it should be noted that the examples described above are provided for purposes of illustration, and are not intended to be limiting. Other devices and/or device configurations may be utilized to carry out the operations described herein.

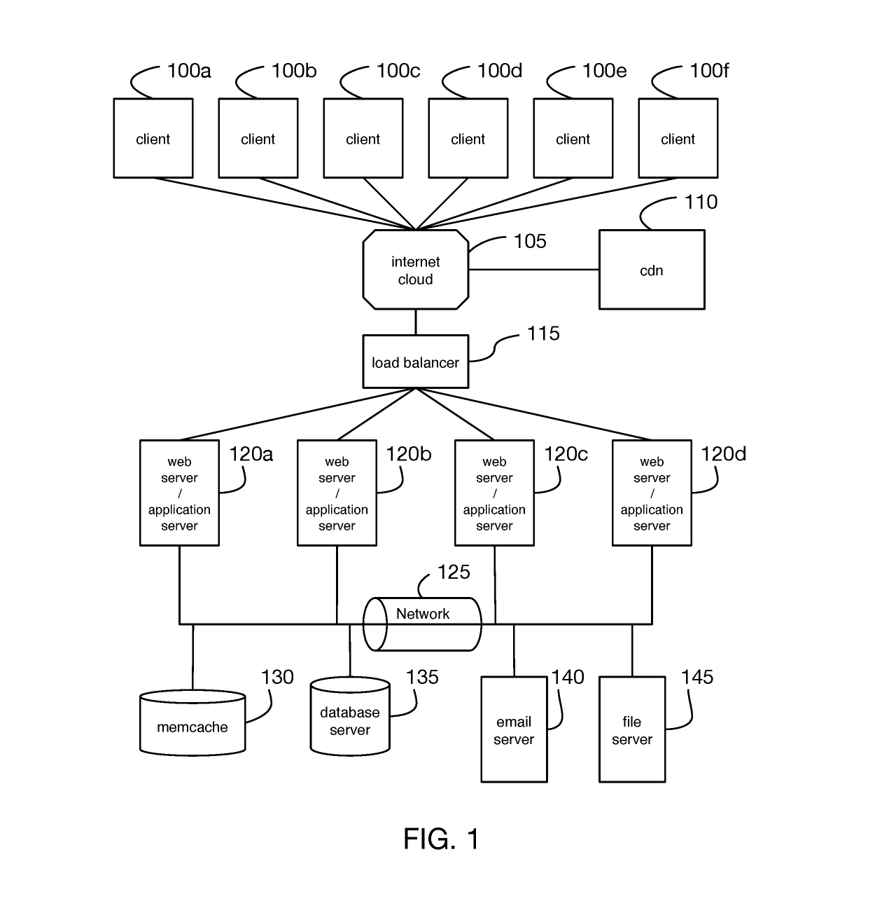

FIG. 1 depicts an example hardware architecture implementing the skill sharing platform. The system may be implemented with any of a wide variety of computing devices or clients 100a-f, such as, but not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

The system may also include a communication network 105, such as a local area network (LAN) and/or wide area network (WAN). In one example, the network includes the Internet or other mobile communications network (e.g., a mobile device network). A content delivery network or CDN 110 may provide greater accessibility to the service for use in distributed environments, for example, where more than one user may have input and/or receive output from the service.

In an example, the system may include one or more host, such as a web server or application server 120a-d providing a service accessed via client device(s) 100a-f. The server computers 120a-d may be provided on the network 105 via a communication connection, such as via an Internet service provider (ISP) or load balancer 115. In this regard, the clients 100a-f are able to access the hosted services directly via the network, or via an agent, such the CDN 110.

For purposes of illustration, the service may be an online data processing service executing on a database server 135, an email server 140, and/or a file server 145. It is noted that the servers may be configured as one or more server computer having access to a computer-readable storage, such as memcache 130. Example services may include general purpose computing services (e.g., access to sources of data sets hosted on the Internet or as dynamic data endpoints for any number of client applications). Services also include interfaces to application programming interfaces (APIs) and related support infrastructure, such as application engines (e.g., processing and graphics engines), and hosted business services.

In addition, the service may provide at least one remote source of content, and/or the service may be operable to communicate with at least one remote source of content. That is, the source may be part of the service, and/or the source may be physically distributed in the network and operatively associated with the service. In any implementation, the source may include any content. For example, the source may include databases for providing information, applications for providing application data, storage resources for providing online storage facilities. There is no limit to the type or amount of content that may be provided by the source. In addition, the content may include unprocessed or “raw” data, or the content may undergo at least some level of processing.

The skill sharing platform and method disclosed herein is a new paradigm in scheduling people for limited engagements. Not only does the platform enable service providers the ability to define a graphical geospatial service area to provide their services, but the platform also provides consumers looking for services with relevant providers and the information they need to schedule an appropriate provider.

A visitor to the platform can search for providers at their geospatial coordinates, or as fallback at an address, without the need to create a user account on the platform. If a visitor decides they would like to request the services of a provider, the platform will prompt them to login or create an account. Alternately, if a visitor would like to create a skill on the platform and become a provider, the platform will prompt them to login or create an account.

Any user of the platform can be a provider, a consumer, or both simultaneously. All users of the platform have a profile page when they can upload an avatar photo, a short biography, and additional photos with comments. If a user decides they would like to provide services, they can map a skill to their profile. A user can create a new skill name of their choosing, or choose an existing skill name. A user can have multiple skills associated with their profile, all with unique attributes. These attributes include, but are not limited to, rate, rate modifier, rate negotiable, request tips, accept bids, geospatial service area, and whether the skill is currently active or disabled.

A consumer on the platform when presented with a list of providers with their given search parameters, their ultimate decision of who to request is governed by the providers score and karma, the providers profile and reviews, and whether they are currently online or recently online with the platform. A consumer can attach multiple providers to a single request, ultimately deciding on one provider when confirming. Conversely, when a provider gets a request from a consumer, their decision on whether to accept the request is governed by viewing the consumers profile and reviews, optionally negotiating a rate, negotiating the schedule, or by private chat within the platform. If all providers attached to a consumer's request, decline that request, the consumer has the option to replace them with other providers until one is ultimately chosen.

Upon completion of a request, the platform requires both consumer and provider to rate their experience before the request is considered closed. The platform limits the count of open requests associated with a given user therefore requiring users to rate their experiences to continue using the platform. These rating are used to generate the score and karma of the other user.

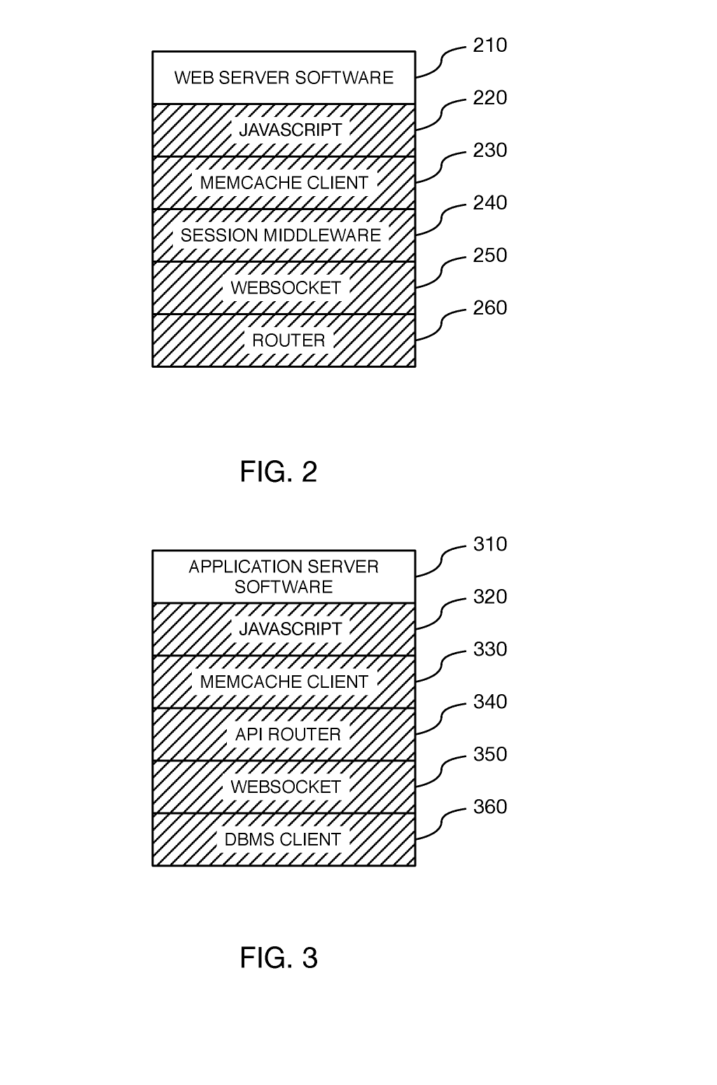

The tasks performed by the platform may utilize a variety of underlying hardware and/or software. FIG. 2 illustrates the software architecture of the Web server layer. FIG. 3 illustrates the software architecture of the application server layer. In an example, the software architecture can be divided into tiers, e.g., a web server, application-server, and database-server. Each tier may be further comprised of one or more hardware and/or software layers. The program code may be executed by any suitable computing device to identify access patterns by the client for content at a remote source. In addition, the program code may serve one or more than one client.

The Web server layer provides a front-end presentation layer for interacting with end users. The Web server layer may include one or more server systems. Any request from an end user may be fielded by any system within the layer. The selected system can contact any application server with the application layer to provide processed data for use in responding to the end user request. Also, the Web server maintains a web socket connection with the user's device, facilitating dynamic event notification and the ability to know when a user is online with the platform. This socket information is stored in memcache 130 and is available to all servers in the Web and Application server layers.

The application layer supports interacting with the database server layer to acquire needed data and processing it prior to presentation by the Web server layer. As with the Web server layer, this layer may consist of one or more interchangeable low cost server systems. Any Web server system may submit a request to any application server. The application server includes processing functionality suitable for the types of pages to be dynamically constructed. Also, the application server validates user uploaded data, and resizes and converts uploaded images to the proper size and type.

The database server layer supports low level management of data used in dynamic page construction. The data store across the one or more low cost server systems is seamlessly viewed as an integrated whole. As a consequence, any database server within the layer can field any request for data submitted by an application server. Also, the database server layer handles all application logic related to the platform, validates user input data prior to storage, and determines when and how a user should be notified of platform events.

In FIG. 2, the Web Server Software 210 implements Node.js (i.e., the server software. It supports serving and rendering scripts using the Javascript scripting language 220. In an example, all HTML content is rendered by Javascript scripts. A Memcache client 230 provides a bridge between the Javascript scripts running on the server and the external Memcache server 230. Session Middleware 240 handles user session creation, validation, and storage in the Memcache 230. A Websocket layer 250 manages websocket connections between the server and user device. Each user device websocket connection is assigned a unique identifier which is stored in the memcache 230. A Router layer 260 handles the page navigation within the platform and resolves user navigation requests to a URL.

In FIG. 3, the Application Server Software 310 implements Node.js (i.e., the server software. The Application Server logic is provided by scripts using the Javascript scripting language 320. A Memcache client 330 provides a bridge between the Javascript scripts running on the server and the external Memcache server 330. The API router 340 handles API calls from the Web Server layer and client devices running the rendered HTML application. A Websocket layer 350 manages websocket connections between the user device and the server. Each user device websocket connection is assigned a unique identifier which is stored in the memcache 330. A database management system (DBMS) Client 360 handles database requests.

An example skill sharing platform includes a computer store including data defining a plurality of skill profiles. Each of the skill profiles corresponds to a service provider offering services. Each of the skill profiles corresponds to defined geospatial service areas. The example skill sharing platform also implements a computer server coupled to the computer store. The computer server may be a dedicated or shared server (e.g., provided via a hosting environment such as a data center and/or “cloud” service provider). The computer server executes to receive a request from a consumer; identify a requested skill profile based on input received from a consumer in the request; provide the requested skill profile to the consumer using the skill sharing platform in a defined geospatial service area; and determine at least one of a score and a karma based on interaction between the service provider and the consumer. The score and the karma may be automatically applied by the computer server to ones of the skill profiles corresponding to the service provider stored in the computer store. The score and karma may be automatically retrieved by the computer server and displayed with the skill profiles in response to future requests by other consumers to influence the other consumers' decisions to generate a request for services.

In an example, the skill sharing platform may be implemented as a method. According to an example method, a computer store includes data defining a plurality of skill profiles. Each of the skill profiles corresponds to a service provider offering services. Each of the skill profiles corresponds to defined geospatial service areas. The example method may execute via a computer server to receive a request from a consumer; identify a requested skill profile based on input received from a consumer in the request; provide the requested skill profile to the consumer using the skill sharing platform in a defined geospatial service area; and determine at least one of a score and a karma based on interaction between the service provider and the consumer. The score and the karma may be automatically applied to ones of the skill profiles corresponding to the service provider stored in the computer store. The score and karma may be automatically retrieved and displayed with the skill profiles in response to future requests by other consumers to influence the other consumers' decisions to generate a request for services.

In an example, the skill sharing platform may be implemented via a computer-readable memory adapted for use by a platform provider in serving web pages. The computer-readable memory may direct a computing device to perform the steps of: receive a request object from a consumer (e.g., via a web browser or mobile application or “app”); identify a requested skill profile based on input received from a consumer in the request; display skill profile object to the consumer using the skill sharing platform in a defined geospatial service area; and determine at least one of a score and a karma based on interaction between the service provider and the consumer. The score and the karma may be automatically applied to ones of the skill profiles corresponding to the service provider stored in the computer store. The score and karma may be automatically retrieved as objects from a storage associated with a computing device, and displayed for the consumer (e.g., via a mobile device or other computing device) with associated skill profile objects in response to future request objects by other consumers to influence the other consumers' decisions to generate a request for services.

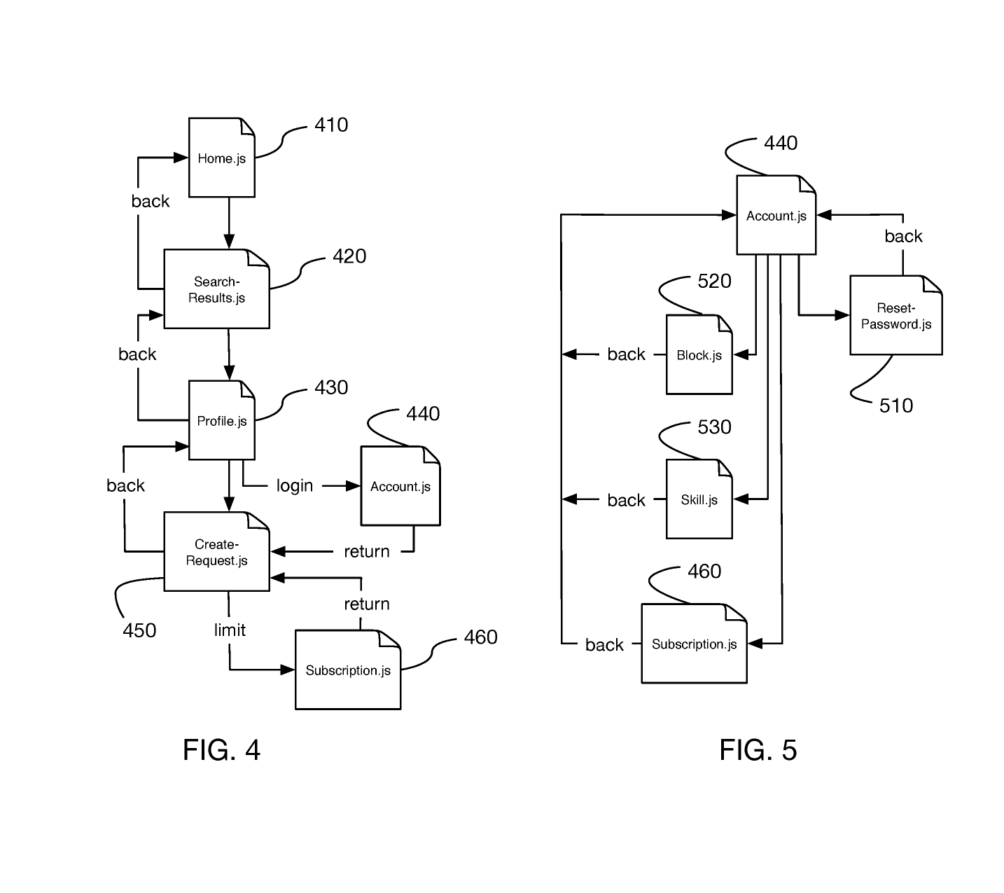

Program code used to implement features of the system can be better understood with reference to FIGS. 4-8 and the following discussion of various example functions. However, the operations described herein are not limited to any specific implementation with any particular type of program code.

FIGS. 4-8 illustrate example operations of an example architecture of machine readable instructions, which may be executed to provide a skill sharing platform. The skill sharing platform is implemented at least in part as computer readable program code. In an example, the program code may be implemented in machine-readable instructions (such as but not limited to, software or firmware). The machine-readable instructions may be stored on a non-transient computer readable medium and are executable by one or more processor to perform the operations described herein. In an example, the program code executes the function of the architecture of machine readable instructions as self-contained modules. These modules can be integrated within a self-standing tool, or may be implemented as agents that run on top of an existing program code.

FIG. 4 is a flow chart of the pages and procedure in the request creation process. In an example, a consumer may search for providers of a particular skill or category of skills. The consumer starts on the Home page 410 by entering the name of the skill they are requesting. The best matching results are listed and the consumer selects a result. Appropriate service providers are displayed on the Search-Results page 420. The consumer can then select service providers and view their Profile page 430. The consumer can then create a request for the service provider on the Create-Request page 450. If the consumer is not logged in, prior to displaying the Create-Request page they are automatically navigated to the Account page 440 where they can login with an existing account or create a new account. When creating a new service request, if the consumer has hit the platform defined limit for the number of open requests they can have, they are navigated to the Subscription page 460 to create or upgrade their subscription.

FIG. 5 is a flow chart of the pages and procedure in the account management process for a user. On the Account page 440 a user can login, create an account. Once logged in they can modify their public Profile such as avatar image, bio, profile images and comments. The user can reset their password on page 510. The block page 520 provides a means for a user to block interaction with themselves and another user either as a consumer or provider. Subscription page 460 allows management or cancelation of a users subscription. On Skill page 530 the user can create a new skill, map an existing skill, or manage the attributes of their skills. A consumer on the platform may be a provider at any time by navigating to the Skill page 530 and adding a skill to their profile. In an example, a provider may select “add skill” and is then given the option to add the skill and any associated details (e.g., a service area). When the provider is satisfied with their profile, the provider may activate that skill.

A provider may create a new skill name or map their account to an existing skill name including other providers. A provider may define their service area for the skill and whether the skill is in an active or disabled state. As such, a consumer searching the specified skill name only sees the provider if predetermined conditions are satisfied. Example conditions include, but are not limited to: the provider's skill is currently in an active state; the provider or the consumer are not on each other's respective block lists, and/or the consumer's geospatial location, or entered address, is within the geospatial polygon defined by the provider.

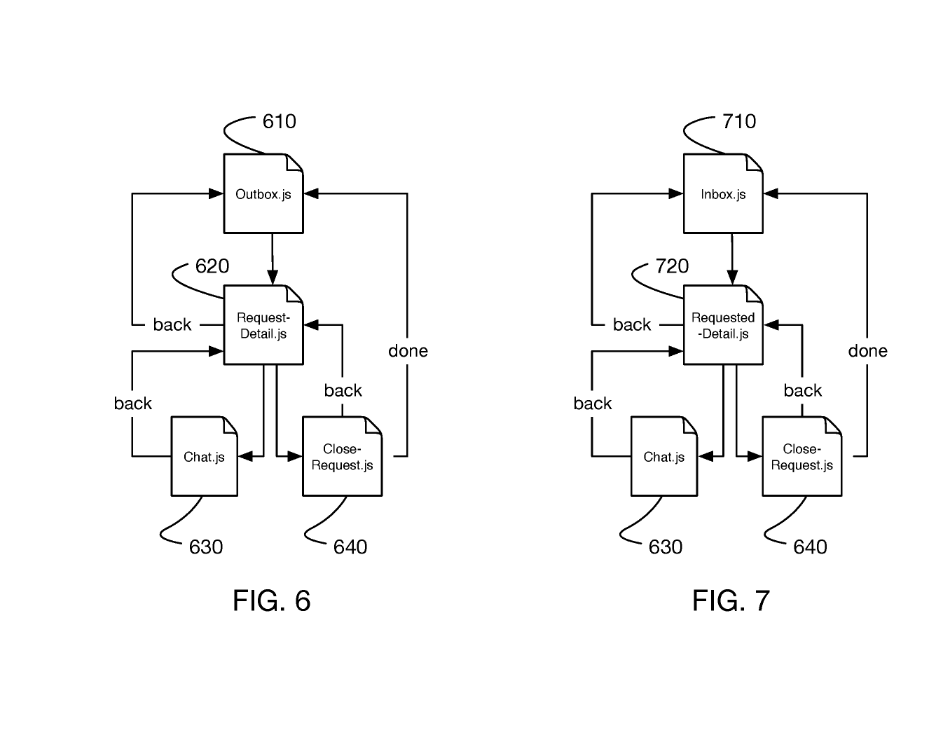

FIG. 6 is a flow chart of the pages and procedure in a consumer's request lifecycle. After a consumer successfully creates a new request 450, the consumer can view the request in their Outbox 610. The Outbox lists all currently open requests and previously completed and closed requests for the logged in user. Open requests display the current status, pending chat notifications, and last updated date and time. Selecting a request from the Outbox navigates to the Request-Detail page 620. On the request detail page the consumer can view or modify details of the request, or cancel the request. The consumer can also create or respond to chat messages on the request by selecting the chat button next to a providers name. The Chat page 630 allows consumer and providers two way communication with text and images. Once the provider has completed the service associated with the request, the consumer selects close request from the Request-Detail page which navigates to the Close-Request page 640. Here the consumer enters a review of their experience, a 1-5 star Karma rating, and 10-100% skill score for the provider.

FIG. 7 is a flow chart of the pages and procedure in a providers request lifecycle. After a consumer successfully creates a new request 450, the chosen provider(s) will be notified and directed to their respective Inbox 710. The Inbox lists all currently open requests and previously completed and close requests for the logged in user. Open requests display the current status, pending chat notifications, and last updated date and time. Selecting a request from the Inbox navigates to the Requested-Detail page 720. On the requested detail page the provider can view details of the request, modify the date and time of the requested service or associated negotiable rates, and accept or decline the request. The provider can also create or respond to chat messages on the request by selecting the chat button next to the consumer's name. The Chat page 630 allows providers and consumers two-way communication with text and images. Once the provider has completed the service associated with the request, the provider selects close request from the Requested-Detail page which navigates to the Close-Request page 640. Here the provider enters a review of their experience and a 1-5 star Karma rating for the consumer.

In an example, requests issued by consumers are issued to the provider. The provider may choose to respond to one or more requests. Or the provider may choose to ignore or decline a request. When a provider declines a request, the provider is removed from the request, and the consumer is notified and given the opportunity to add a different provider to the request. When a provider accepts a request, the consumer is notified and any terms may be negotiated between the consumer and the provider. Once details are agreed upon, the request may be confirmed. Other providers attached to the request are removed from further consideration.

In an example, after services are rendered, the consumer is able to rate the service. In an example, the consumer can rate the service on at least score and/or karma. The rating is implemented in an algorithm and assigned to the provider. The rating is provided to other consumers for deciding whether to work with a particular provider (or guild).

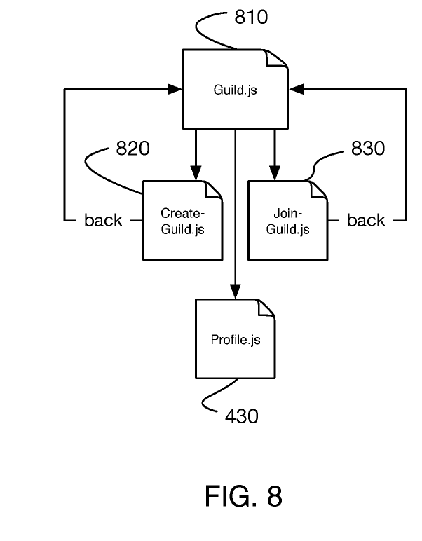

FIG. 8 is a flow chart of the page and procedure in the guild master and member process. In an example, the skill sharing platform also enables a user to generate a “guild.” As used herein, the term “guild” means multiple providers generally providing the same or similar services (and/or products). Guilds enable a group of users to service a larger geographic area, accept more requests, and absorb negative reviews, more readily than an individual may be able to do. Guild management begins by navigating to the Guild page 810. A provider can create a new guild by selecting create guild which navigates to the Create-Guild page 820. A provider who has been invited to an existing guild can join by selecting join guild which navigates to the Join-Guild page 830. From the guild page a provider can also manage which of their skills are mapped to a chosen guild by selecting their profile 430.

A guild may also have a “guild score” and a “guild karma.” These refer to a user's proficiency (score) and rating (karma), as already defined above but with respect to the guild rather than an individual user. In an example, the guild score is an average of the score of the guild's current members. Also in an example, the guild karma is an average of the karma of the guild's current members.

Before continuing, it should be noted that the examples described above are provided for purposes of illustration, and are not intended to be limiting. Other devices and/or device configurations may be utilized to carry out the operations described herein.

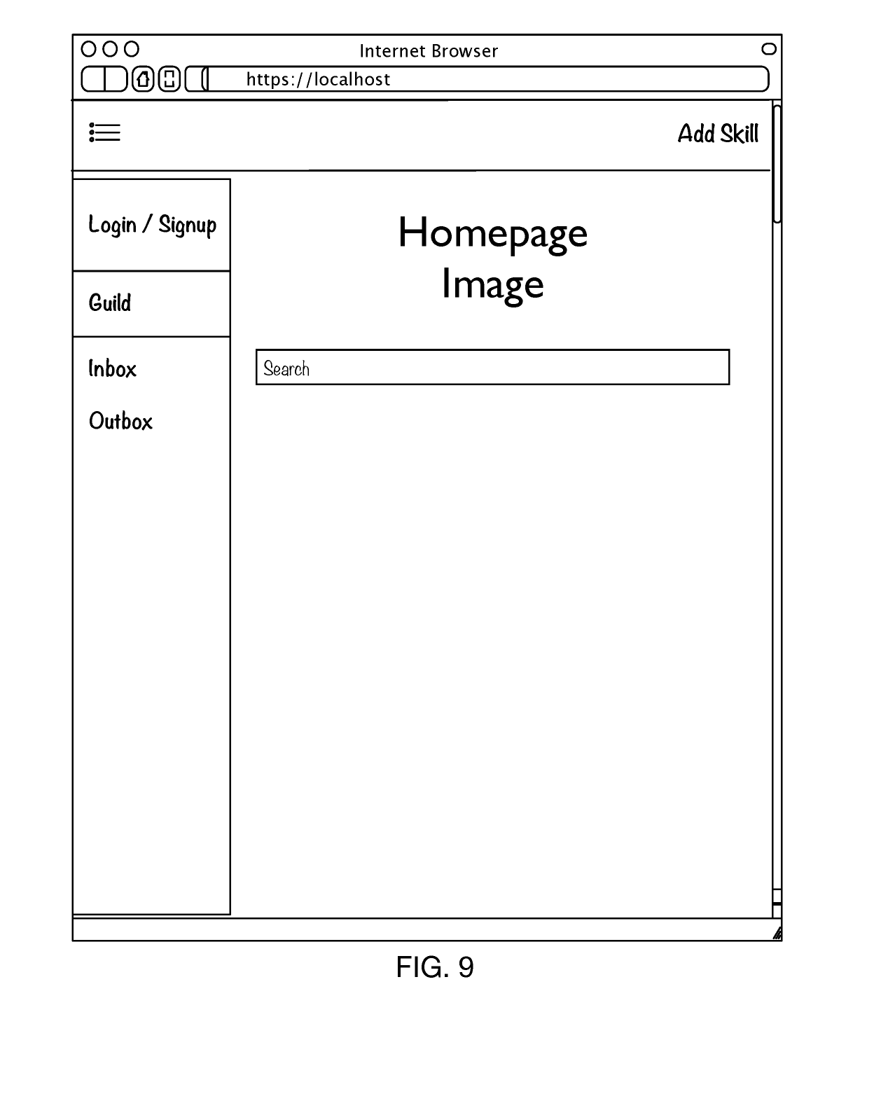

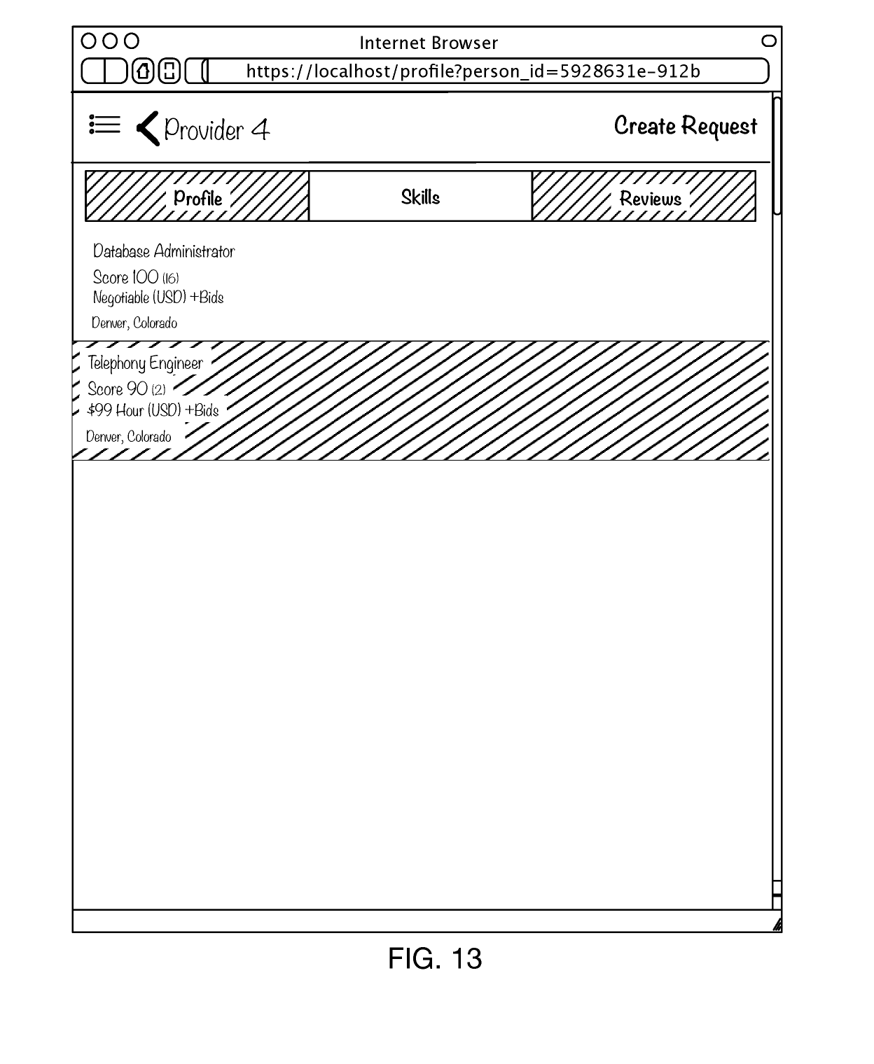

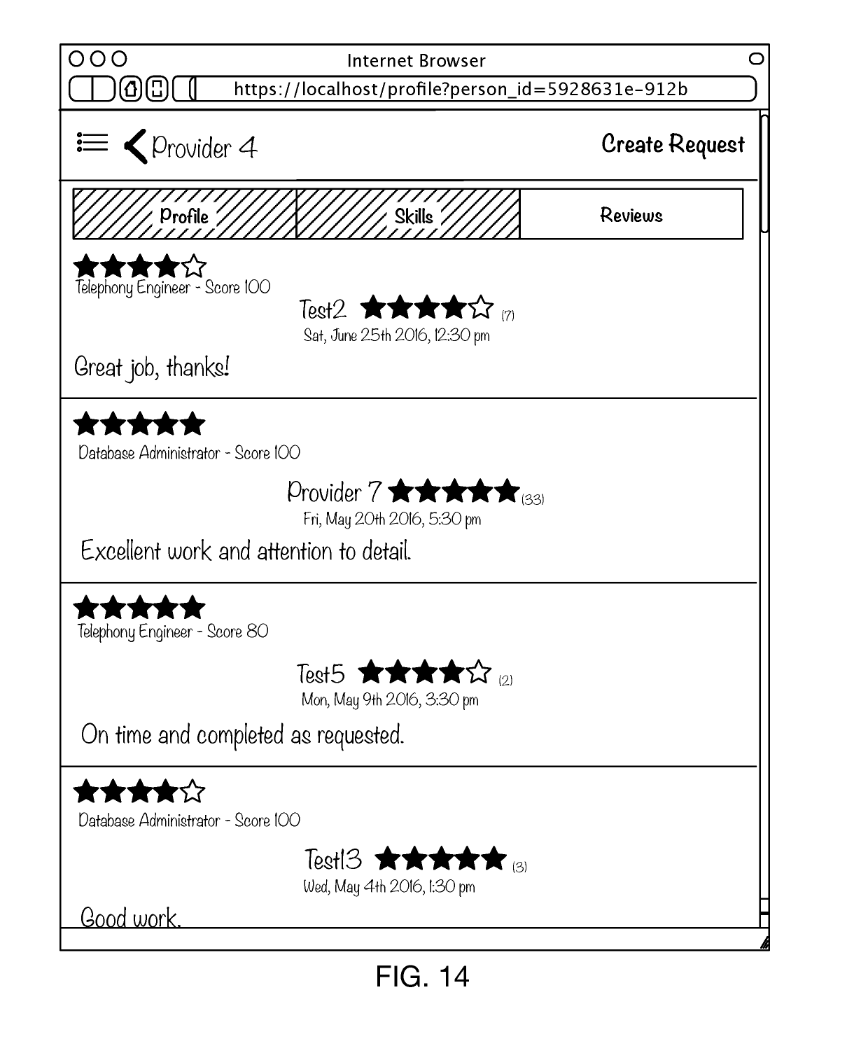

FIGS. 9-37 illustrate example operations which may be implemented to provide a skill sharing platform. Operations may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that example operations are illustrated by screenshots shown in the figures. The screenshots are provided only for purposes of illustration of an example operating environment, and are not intended to limit implementation to any particular configuration. In addition, the operations shown and described herein are provided to illustrate example implementations. The operations are not limited to the ordering shown. Still other operations may also be implemented.

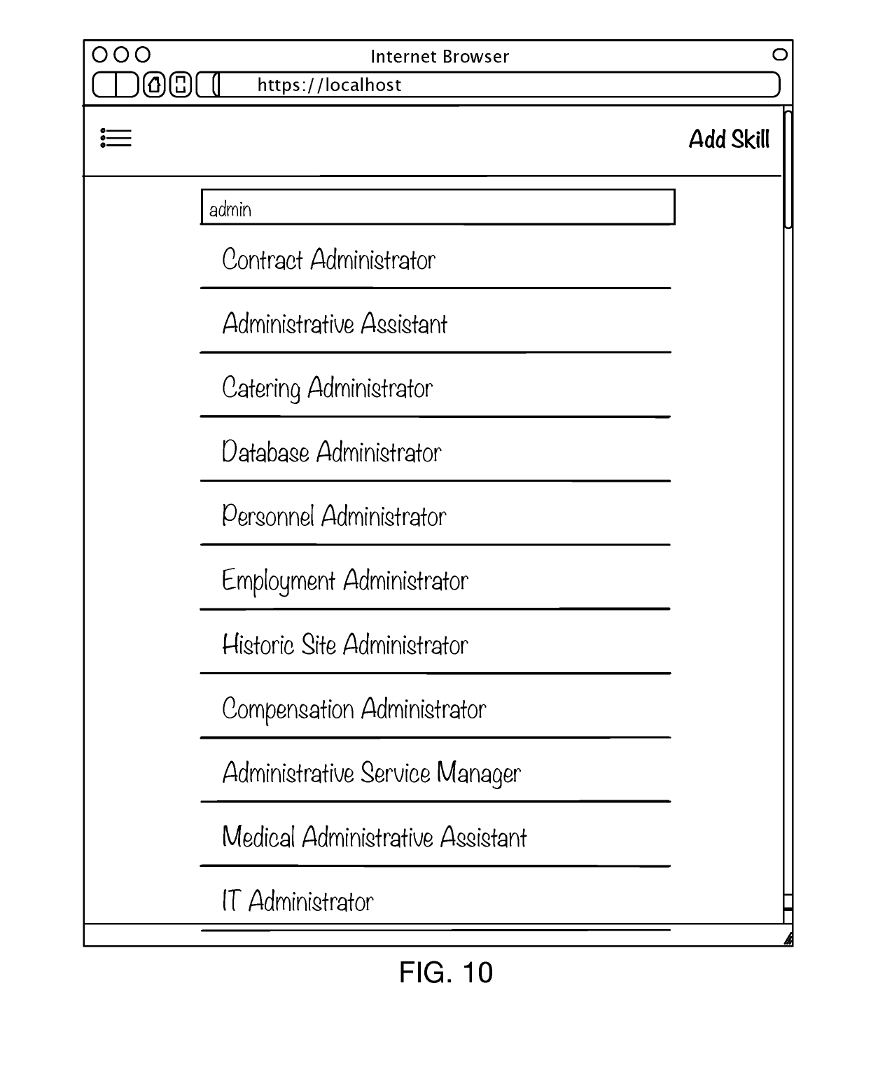

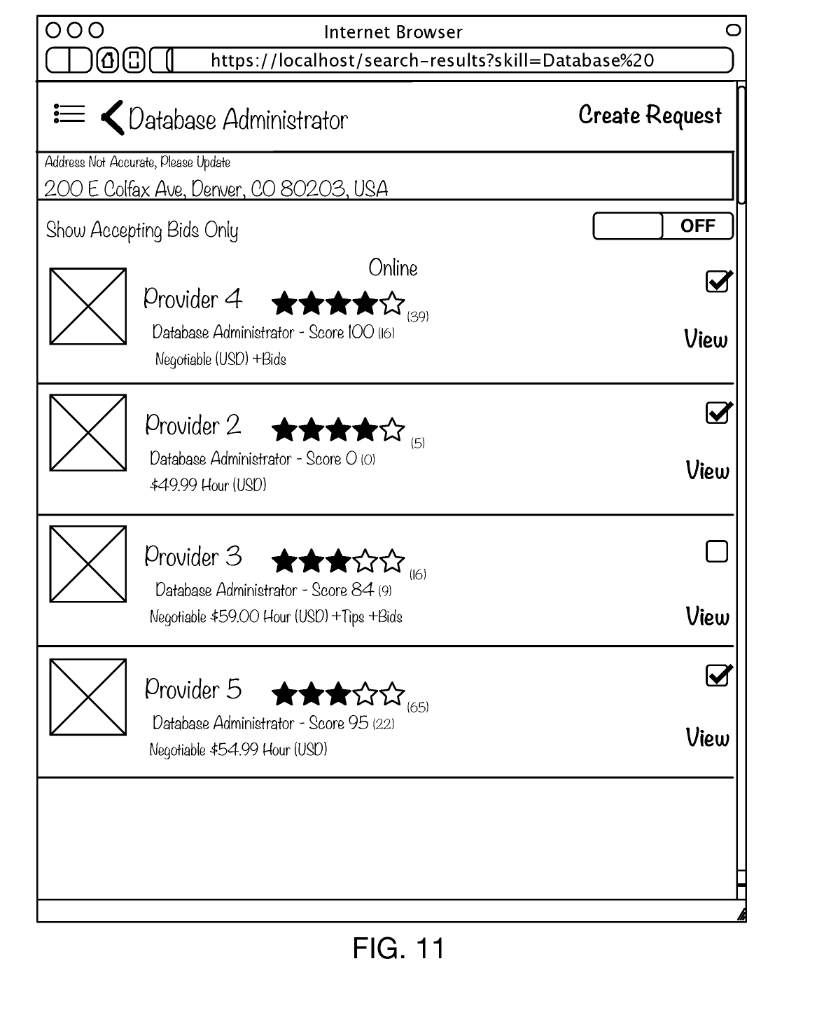

Skill Search. The Home page of the platform as seen in FIG. 9 provides the ability to search for provider skills. Page navigation is provided by a slide out tray to the left with buttons for navigating to the Account (Login/Signup), Inbox, and Outbox pages. A visitor enters their search term in the search box and the page returns a best matched list of results as seen in FIG. 10. The results are sorted by best possible match based on a natural-language similarity with the entered search term. Selecting one of the results navigates to the Search-Results page as seen in FIG. 11.

A sorted list of providers is returned based on the selected skill, the providers service area in relation to the address of the visitor, and whether the providers skill is active. The list may be sorted by the provider's online status with the platform, their karma rating, and skill score. The visitor's address is determined by calling the Geolocation API (e.g., as specified by W3C in https://www.w3.org/TR/geolocation-API/, hereby incorporated herein by reference in its entirety) on the visitor's device. The results of the Geolocation API query are show at the top of the page, and if the results are not sufficiently accurate, as determined by the accuracy result, then the visitor is notified that the address is not accurate and given the opportunity to update the address detected. If Geolocation fails for any reason, and there is no address cached from previous results, then the visitor is prompted to enter an address before results can be computed and displayed.

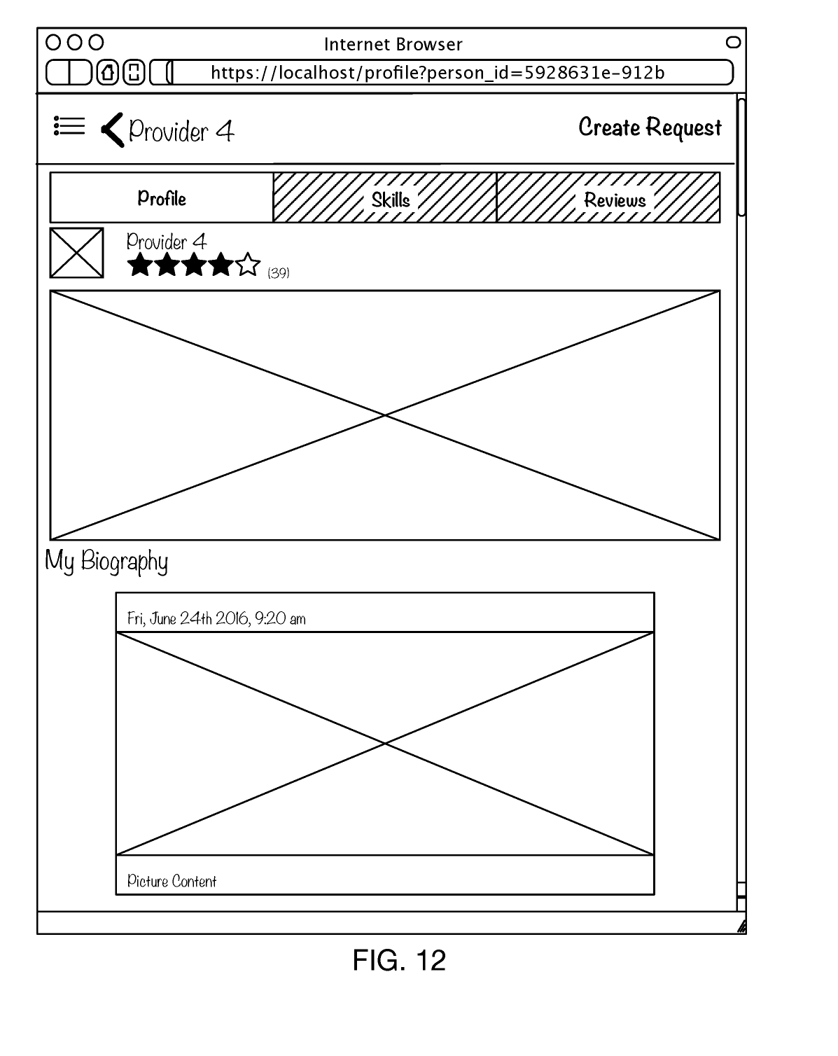

A visitor can select view next to a provider's username to navigate to the providers Profile page as seen in FIGS. 12-14. Here they can view a provider's profile image, biography, other images, skills, and reviews of the provider by consumers on the platform.

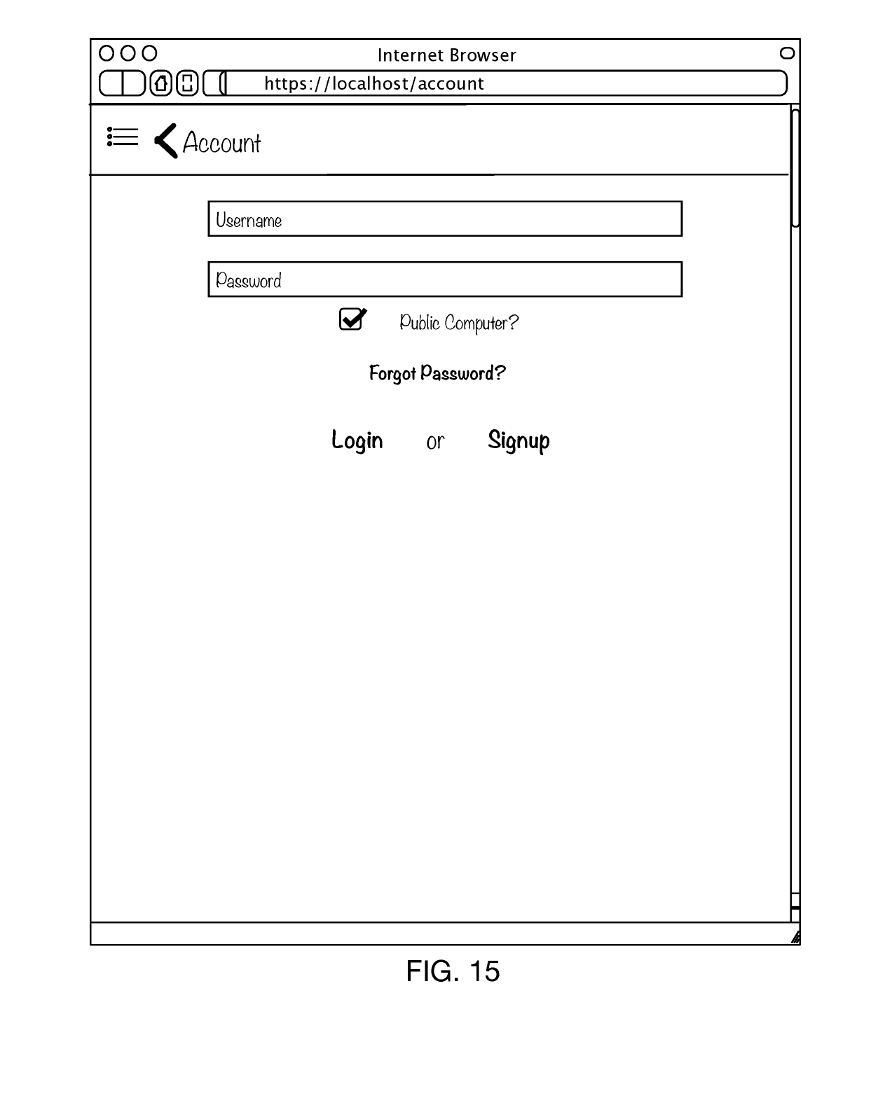

Account and Skill Creation. Up to this point, a visitor on the platform does not have to be registered on logged into the system. This provides the ability for visitors to see what is available on the platform without commitment. To continue and create a request for one or more providers, or to become a provider themselves, a visitor needs to login or create an account on the platform by navigating, or automatically be navigated to, the Account page as see in FIG. 15.

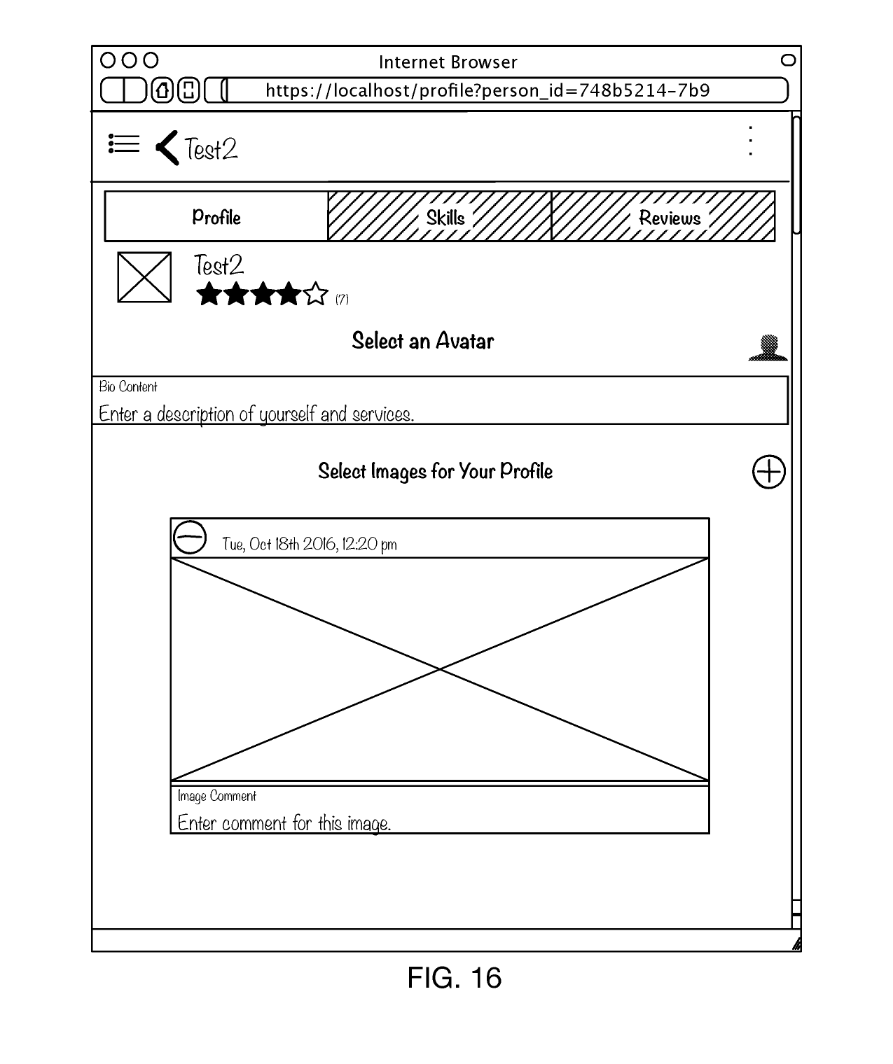

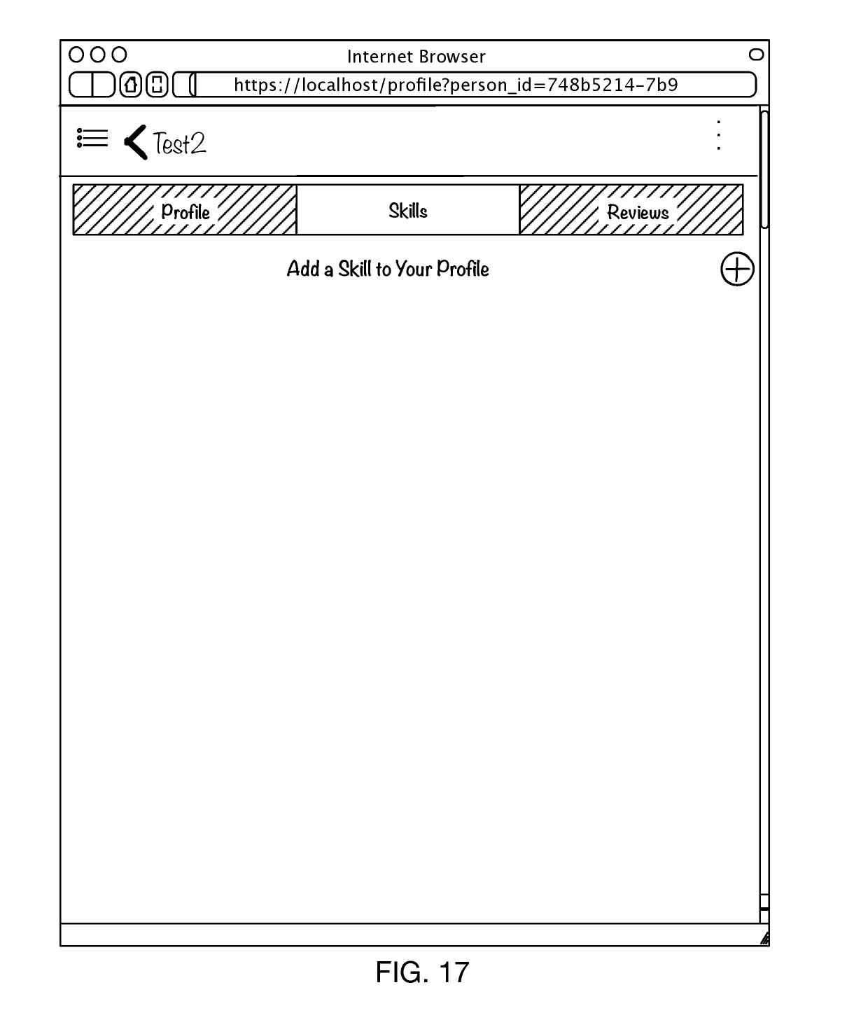

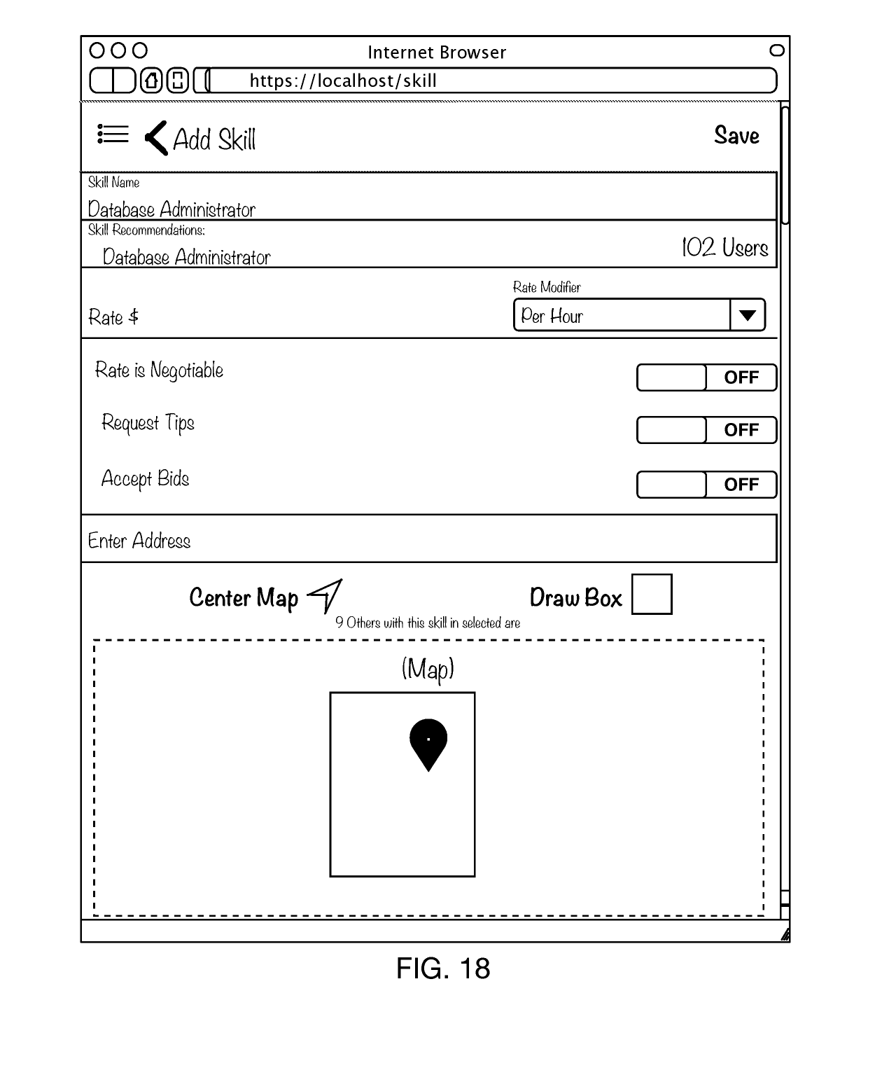

After creating or logging in with an account, a user can modify their profile as seen in FIGS. 16-17. Here a user can upload a profile image, biography, other images and comments, view and create skills, and view their reviews. A user can also add a skill to their profile and become a provider at any time as seen in FIG. 18. Here a user defines their provider skill first by selecting a name. The platform returns a list of recommended skill names and the number of users on the platform with those skills. This allows a user to map their skill to a skill name that the majority of users are using, or to create a new skill name. The user defines a rate and rate modifier for their skill, whether that rate is negotiable, requested tips, and whether to accept request bids. The map on the page is used to define the service are of the user's skill. The Center Map button re-centers the map to the user's current geospatial location or an entered address. The Draw Box button places a box overlaying the center of the currently view map. The user can then select the edges of this box overlay to position and resize it to their desired service area. Once the skill has been saved, users searching for the specified skill within the service area that was defined will see the provider in their Search Results list.

A provider can change their skill rate, rate modifier, rate negotiable, tips, bids, and service area at any time. They can also disable their skill temporarily so they no longer show up in search results. Any changes to their skill do not affect requests that are already open or closed.

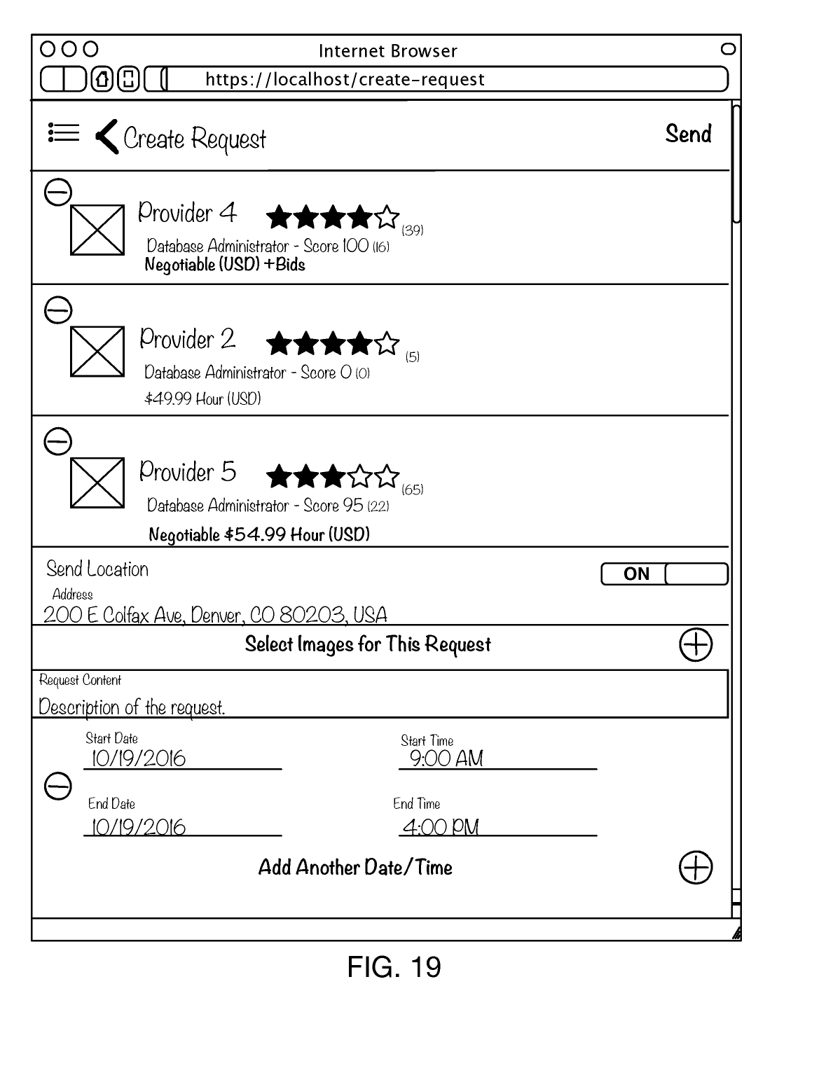

Request Creation. To create a request, a registered user can select Create Request while on a providers Profile page, or alternately while on the Search-Results page select multiple providers via their radio boxes. This will navigate to the Create-Request page as seen in FIG. 19. On the Create-Request page a consumer can add or remove multiple providers to the request. This allows the consumer to create one request for multiple possible providers and then depending on the provider's response and other possibilities, the consumer can choose their best match. If the provider has a negotiable rate for their skill, the consumer can select an initial rate they would prefer for the request. The consumer creates the content of the request, entering a description of the nature of the request, attach images with comments, a preferred scheduled date and time, and an optional geospatial location or address to the request.

While the consumer is on the Create-Request page, if more than one provider is listed and they are all available for bids with the given skill, then the consumer can enable the bid function. When enabling bids the consumer has to define a time for the bidding to end. Before this time, the providers requested have the opportunity to bid against one another. Once bidding ends the consumer can choose any of the providers requested, and not necessarily the lowest bidder. To protect providers from being unfairly bid down, while bidding providers can see the username, score, and karma of whom they are bidding against. This gives the provider the option to not try and outbid another provider with a lower score or karma than themselves.

Once the consumers request has been created a notification is sent to all the providers requested. If the provider is currently logged into the platform with an open web socket to the server, then an immediate notification is sent to the provider via the WebSocket API (e.g., as specified by W3C in https://www.w3.org/TR/websockets/, hereby incorporated herein by reference in its entirety) to notify them of the new request. If the provider is not logged in, then the notification is sent via email or text message to the providers registered address.

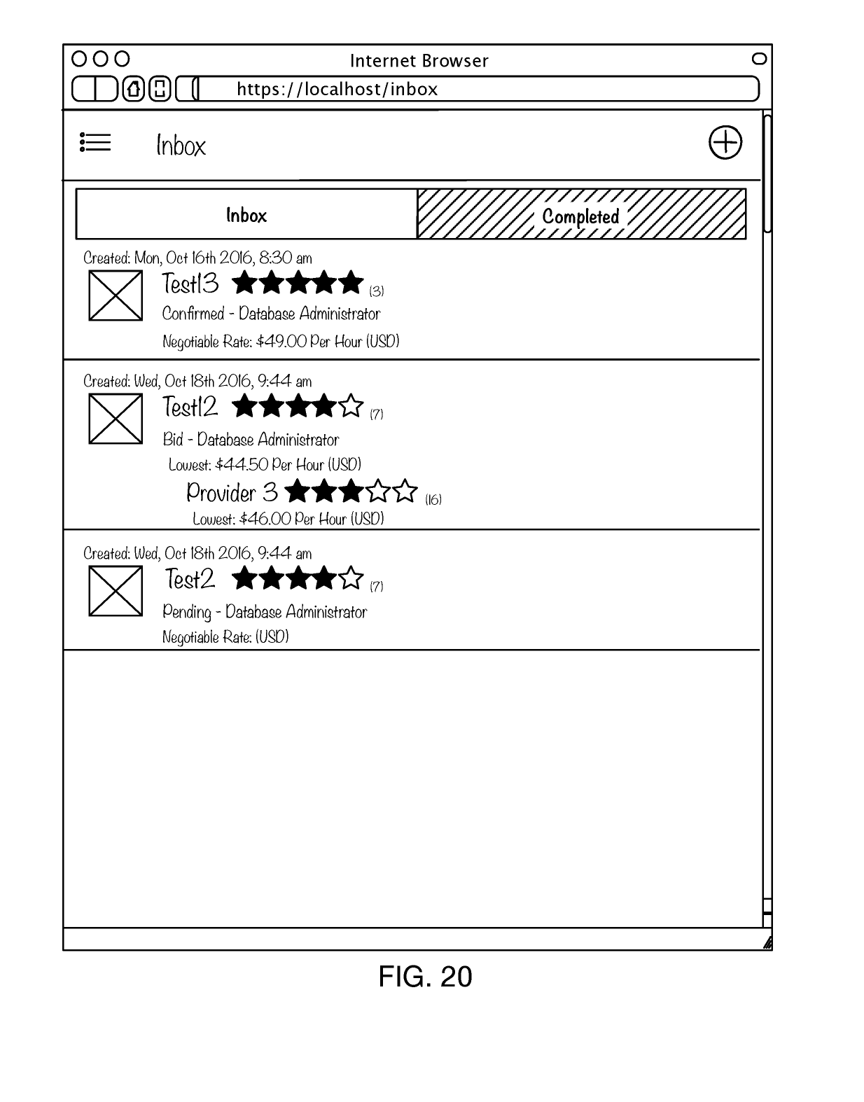

Request Acceptance and Confirmation. The Inbox page as seen in FIG. 20 shows the provider a list of all requests for them on the platform. The Inbox tab shows open requests, and the Completed tab shows completed requests. Open requests are either new requests that have yet to be accepted, accepted requests that have yet to be confirmed, confirmed requests that have yet to be completed, and completed requests that have yet to be closed. Completed requests are requests that have been closed. The Inbox provides information about who the request is from, what skill it is for, rate information, chat notification, and the current status of the request.

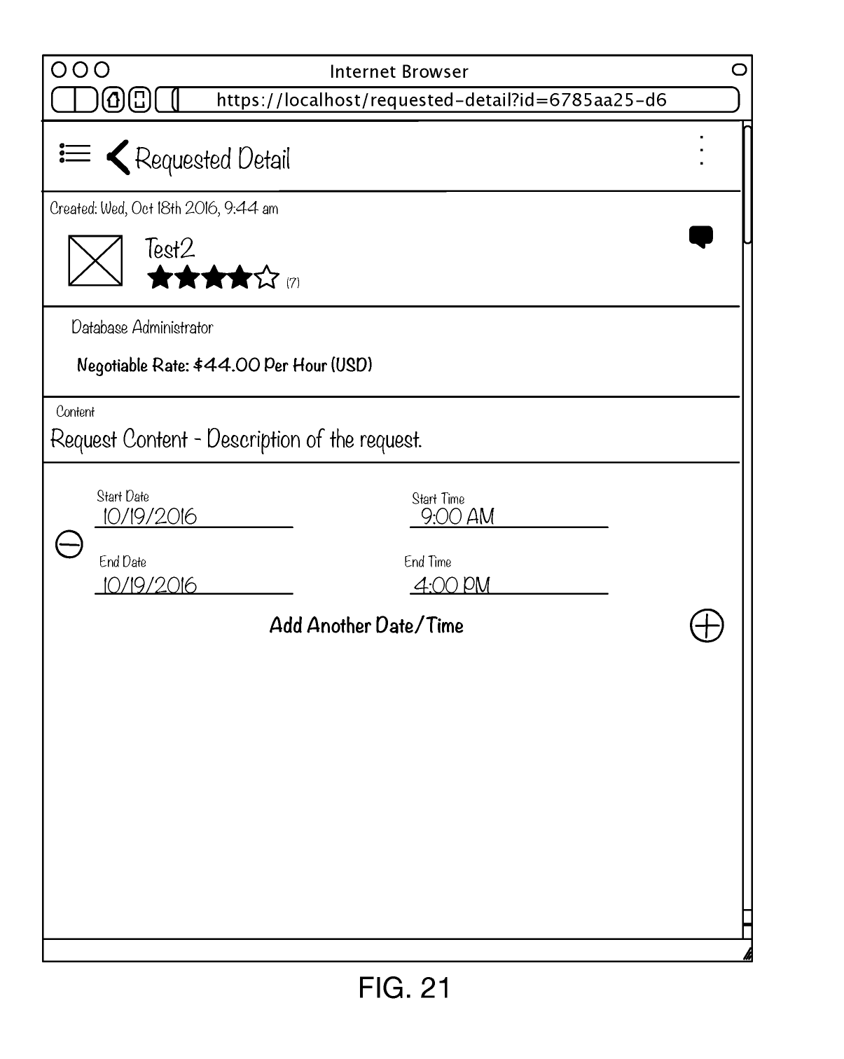

Selecting a request from the Inbox navigates to the Requested-Detail page as seen in FIG. 21. Here the provider can see who created the request, the content of the request, images and comments, rate, rate tips, bid, geospatial location or address, schedule, and chat notifications. The provider has the ability to change the requested rate if their skill was set to a negotiable rate at the time the consumer created the request. Also, they can set rate tips if tips are requested and change the scheduled date and time. The provider can also initiate a chat for the request between themselves and the consumer.

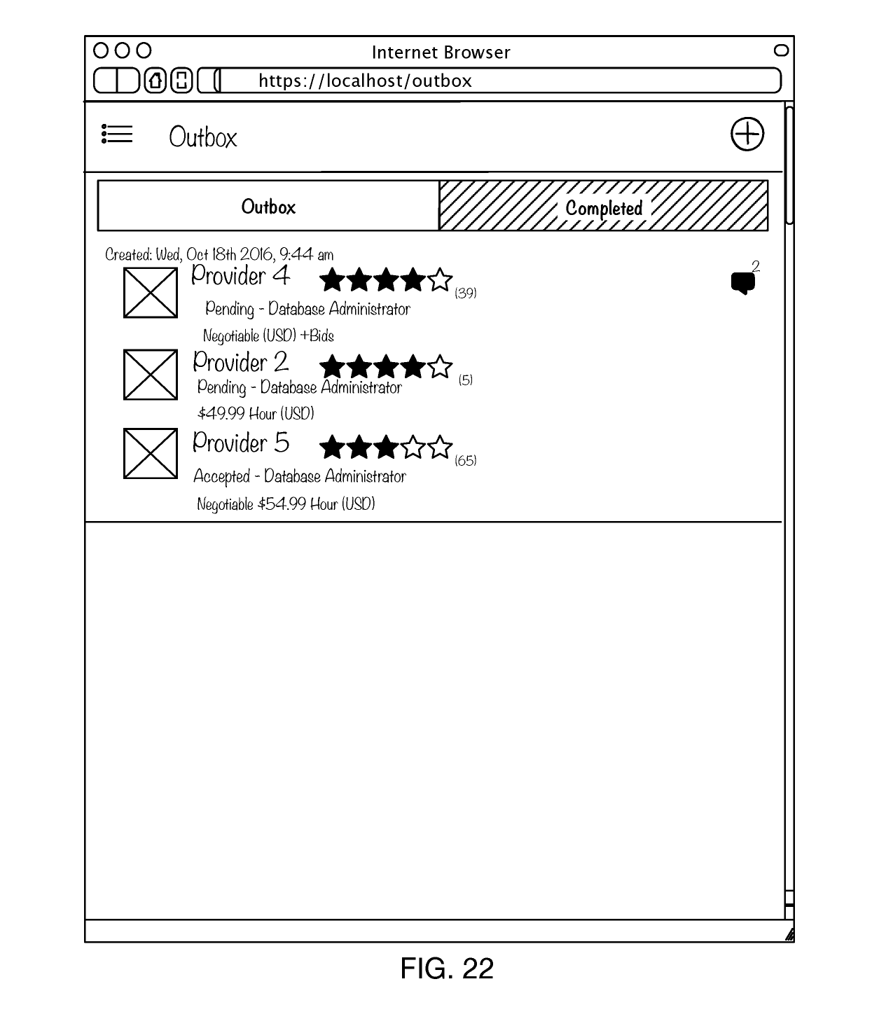

The Outbox page as seen in FIG. 22 shows the consumer a list of all requests they have created on the platform. The Outbox tab shows open requests, and the Completed tab shows completed requests. Open requests are either pending requests that have yet to be accepted, accepted requests that have yet to be confirmed, confirmed requests that have yet to be completed, and completed requests that have yet to be closed. Completed requests are requests that have been closed. The Outbox provides information about who the request is for, what skill is requested, rate information, chat notification, and the current status of the provider's response to the request.

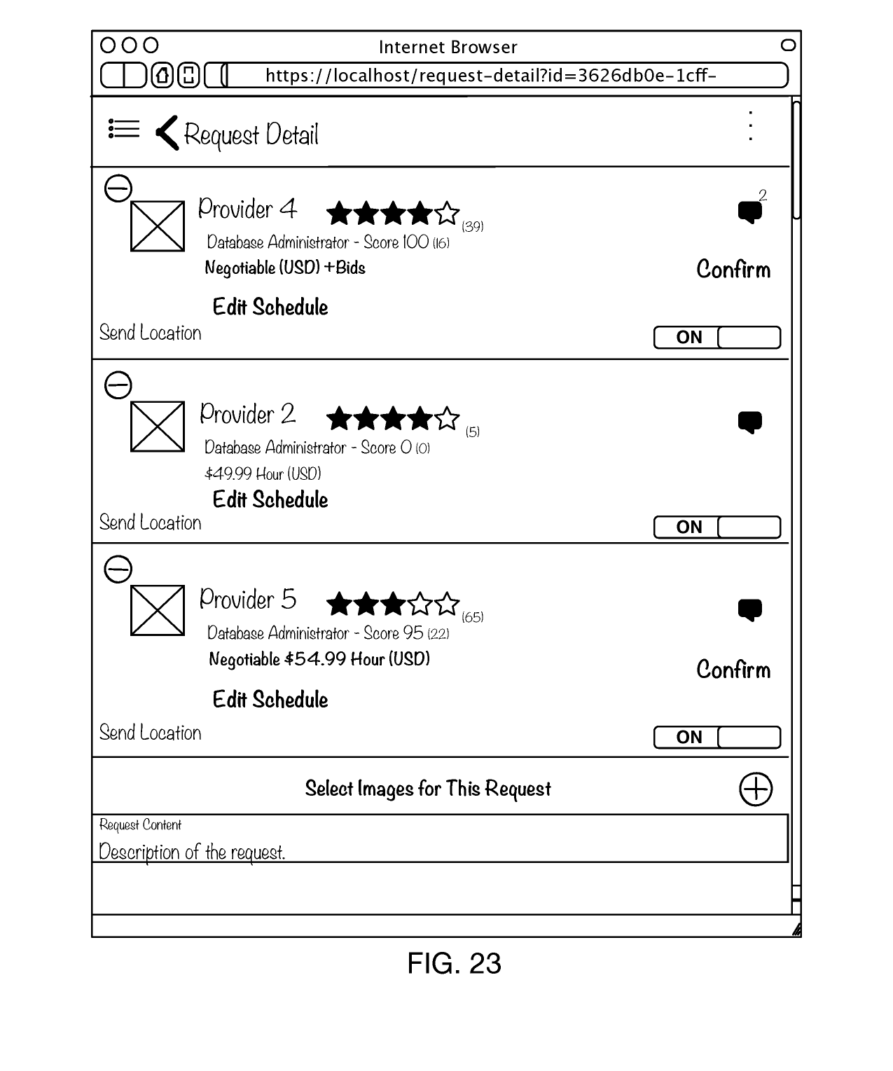

Selecting a request from the Outbox navigates to the Request-Detail page as seen in FIG. 23. Here the consumer can control what providers they have attached to the request, change the content description of the request, and attach images and comments. The consumer can also attach geospatial coordinates to the request, and control which providers have the ability to view this information on the request. Also, the consumer can negotiate rates and schedules individually with each provider attached to the request, or initiate a chat between themselves and the requested provider. Chat notifications for each provider are shown next to the providers information, and each chat session is separate for each provider.

Changes to the rate, rate tips, and schedule can be negotiated in real-time. Changes by either the consumer or provider immediately notify the other side via web socket, text, or email. If the other side is logged in and viewing their side of the request, the page will automatically update with the new rate, rate tips, bid, schedule, and request status.

Bid requests also update all logged in parties involved. This allows bidding between providers in real-time, and for the consumer to watch the bidding in real-time.

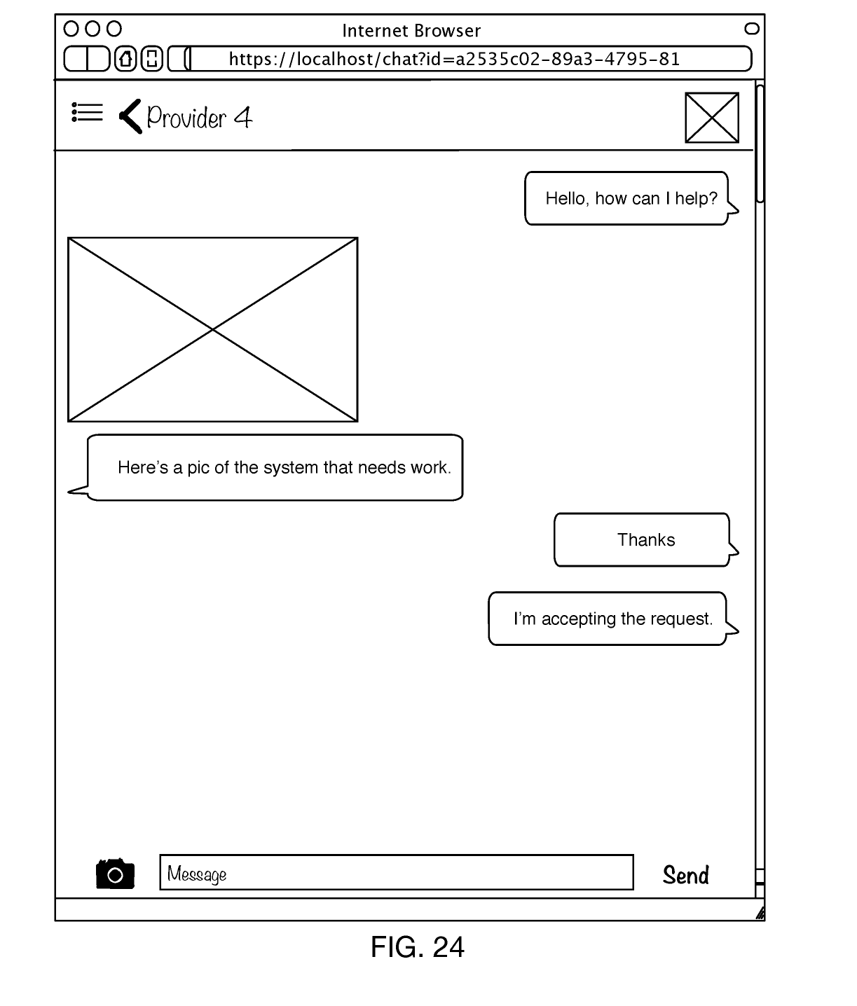

The request Chat page as seen in FIG. 24 updates in real-time, and allows consumer and provider to communicate the finer details of the request. Request chats are tied to the specific request and only viewable by the consumer and provider involved.

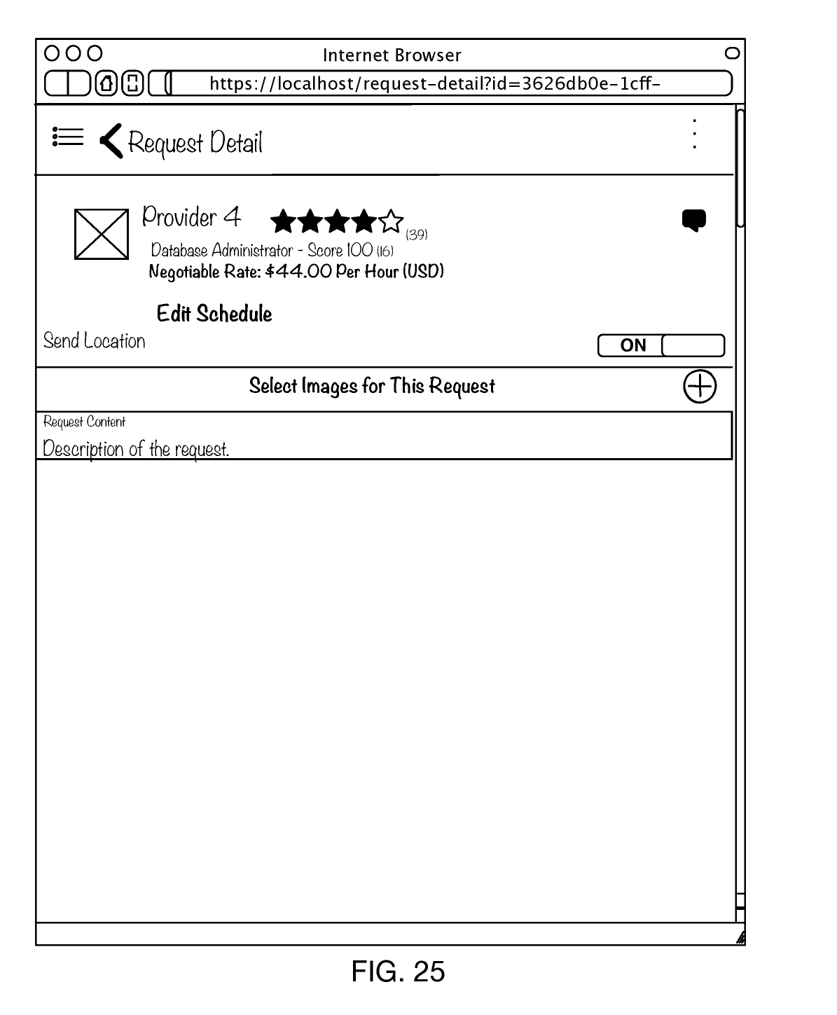

The next step is for the provider to either decline or accept the request. Declining the request will remove it from the provider's inbox and notify the consumer giving them the opportunity to replace that provider on the request. After the provider accepts a request, all items in the request that are modifiable by the provider are still available. Once the consumer confirms a provider's acceptance of the request, negotiable rate and rate tips are locked in and non-editable. The schedule is still modifiable by both sides, and the consumer can update images and comments, and the geospatial coordinates of the request. If this was a bid request, the consumer will have to wait until the bid timer they specified has expired before confirming a winning bid provider. A consumer's confirmation of a provider attached to a request locks that request to the chosen single provider on the Request-Detail page as seen in FIG. 25. All other providers that may have been previously attached are removed and the request is deleted from the removed provider's inbox. The consumer and provider will continue to use the request for communicating changes to schedule and location, and for chat until the request is closed. Once the request has been closed no modifications to the request can be made and chat is disabled. Both side will be able to view the closed request and chat via their completed list, but it is static and not modifiable.

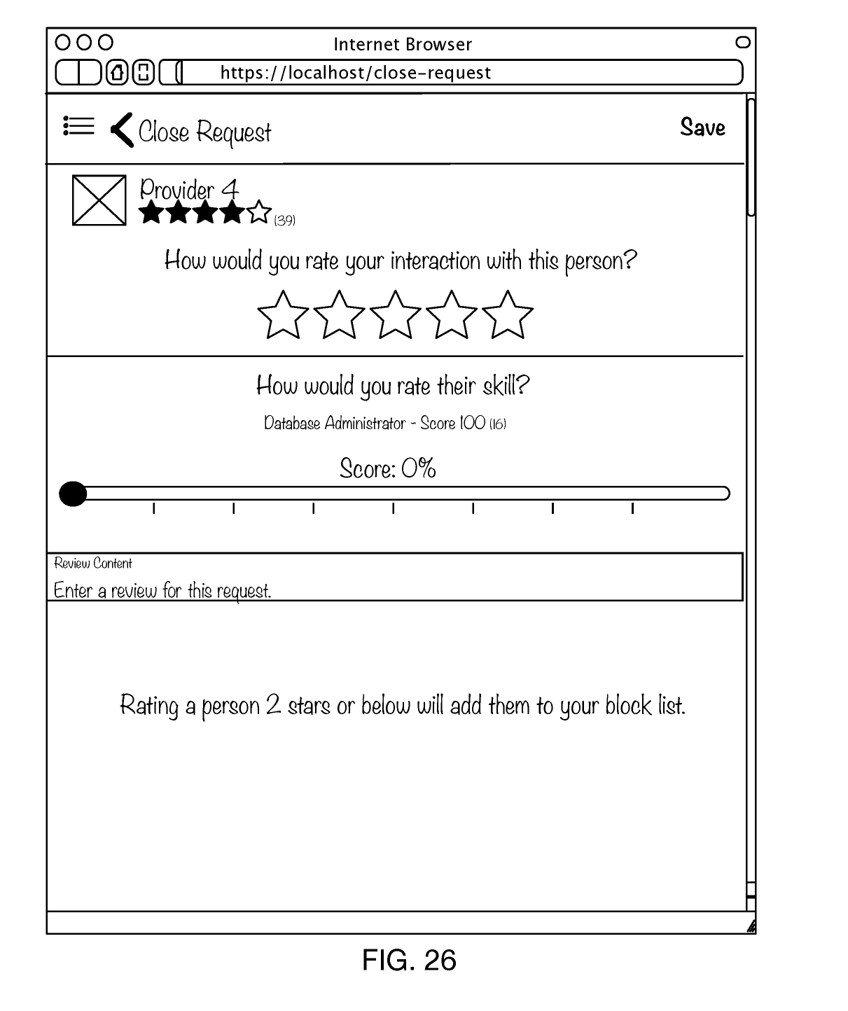

Request Completion and Closure. Once the request is completed it must be closed. When the consumer chooses to close their side of the request, they are navigated to the Close-Request page as seen in FIG. 26. Here the consumer enters a rating for the provider's karma as a person, a score for their proficiency in the skill provided, and a written review. If the consumer rates the provider's karma at less than 3 stars, the provider will be added to the consumers block list.

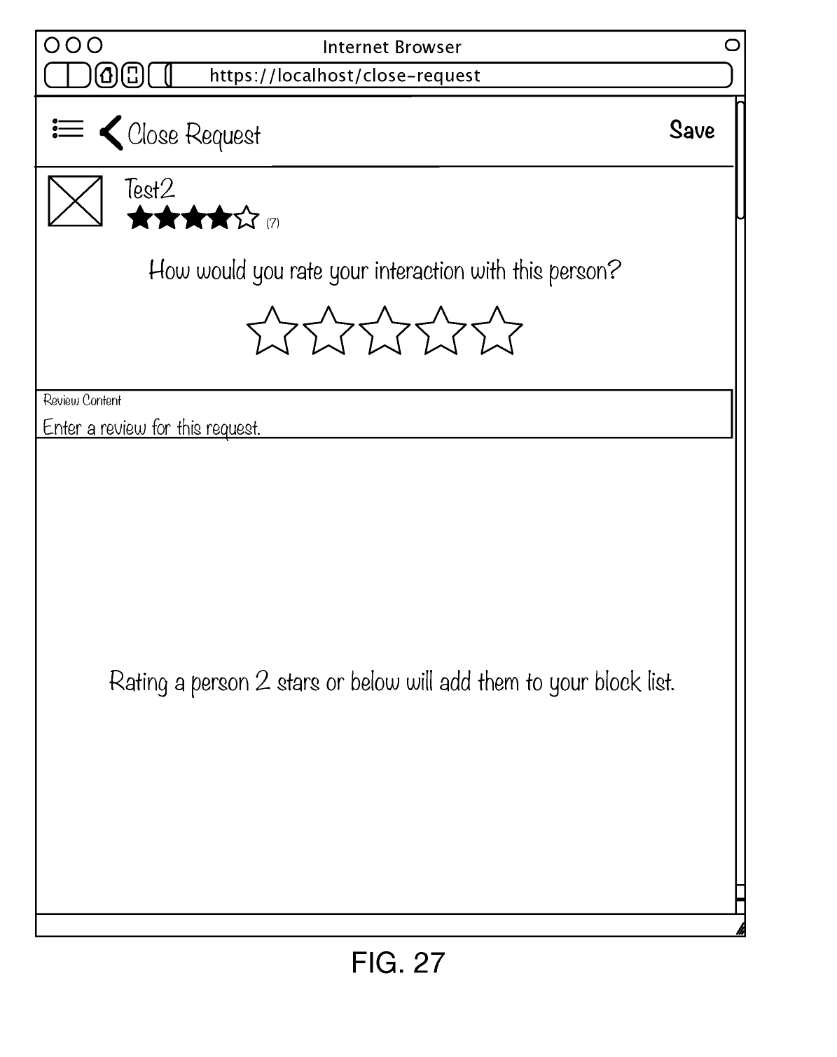

When the provider chooses to close their side of the request, they are navigated to the Close-Request page as seen in FIG. 27. Here the provider enters a rating for the consumer's karma as a person and a written review. If the provider rates the consumer's karma at less than 3 stars, the consumer will be added to the provider's block list.

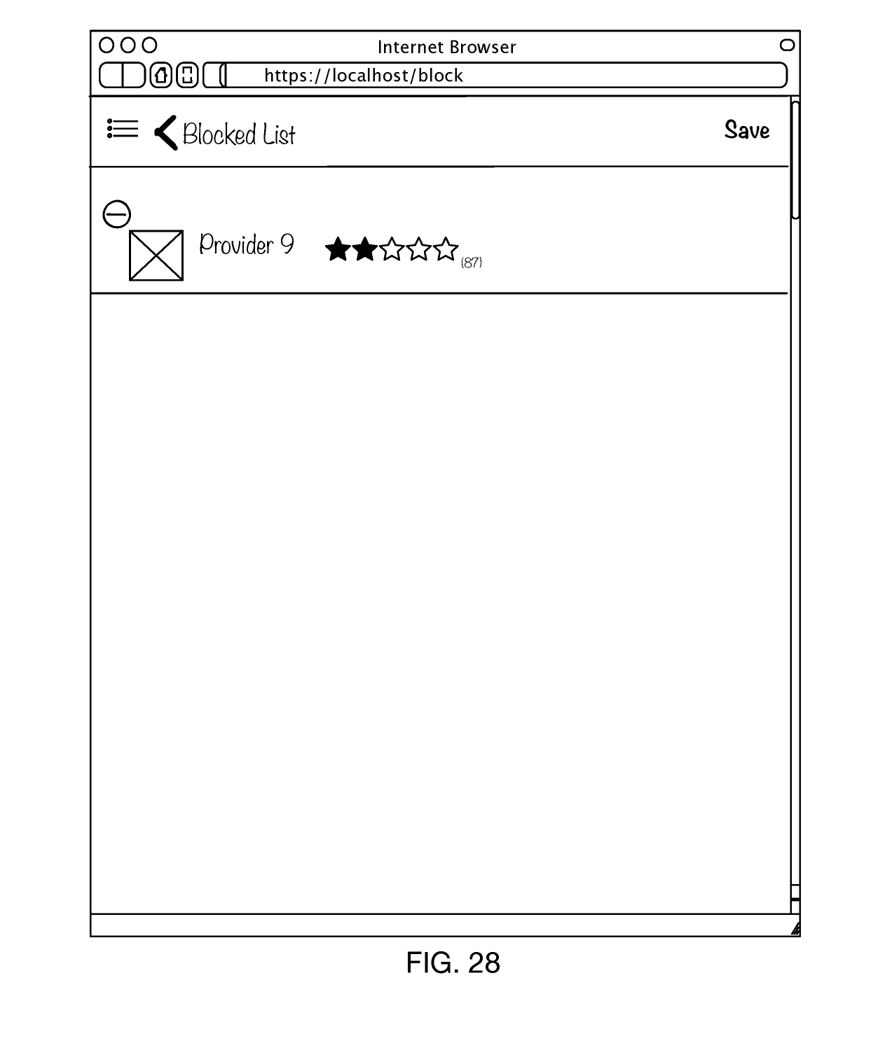

The Block page as seen in FIG. 28 provides a user with a list other consumers or providers that they have blocked. The user can remove another user from the list at any time. As a consumer, a blocked provider will not show up on the Search-Results page when searching for skills. As a provider, a blocked consumer will not see the provider on the Search-Results page when searching for skills.

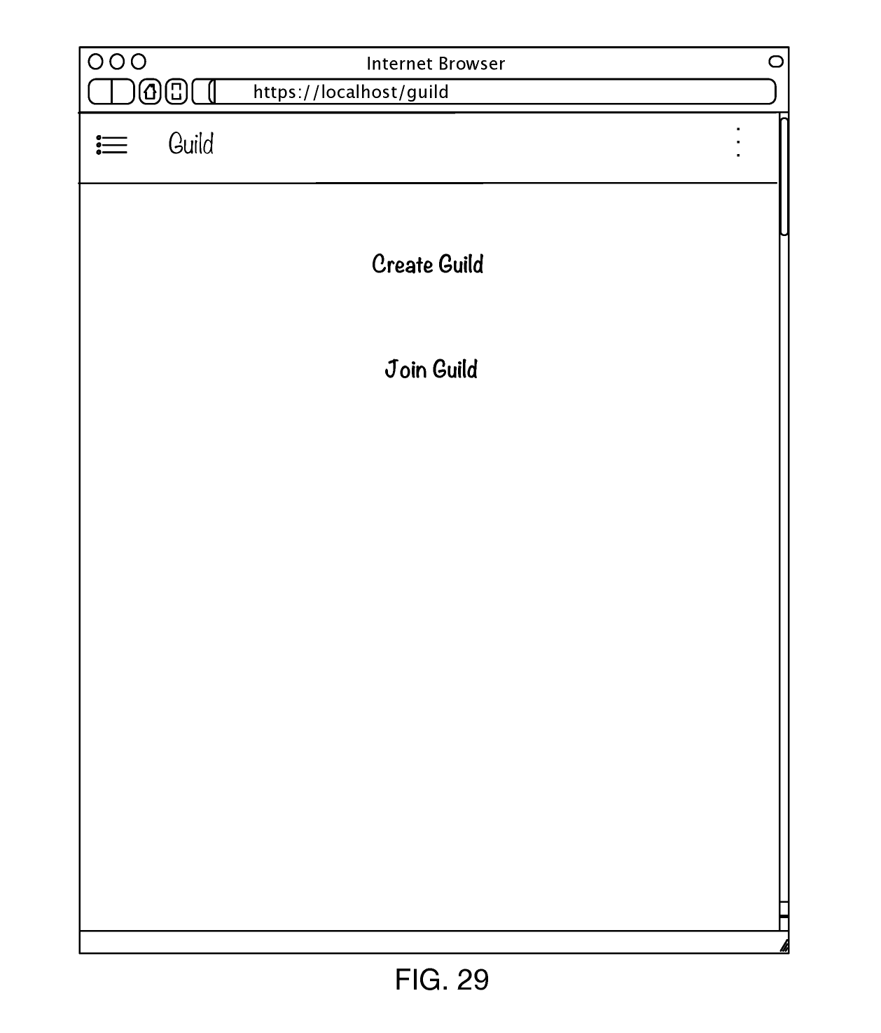

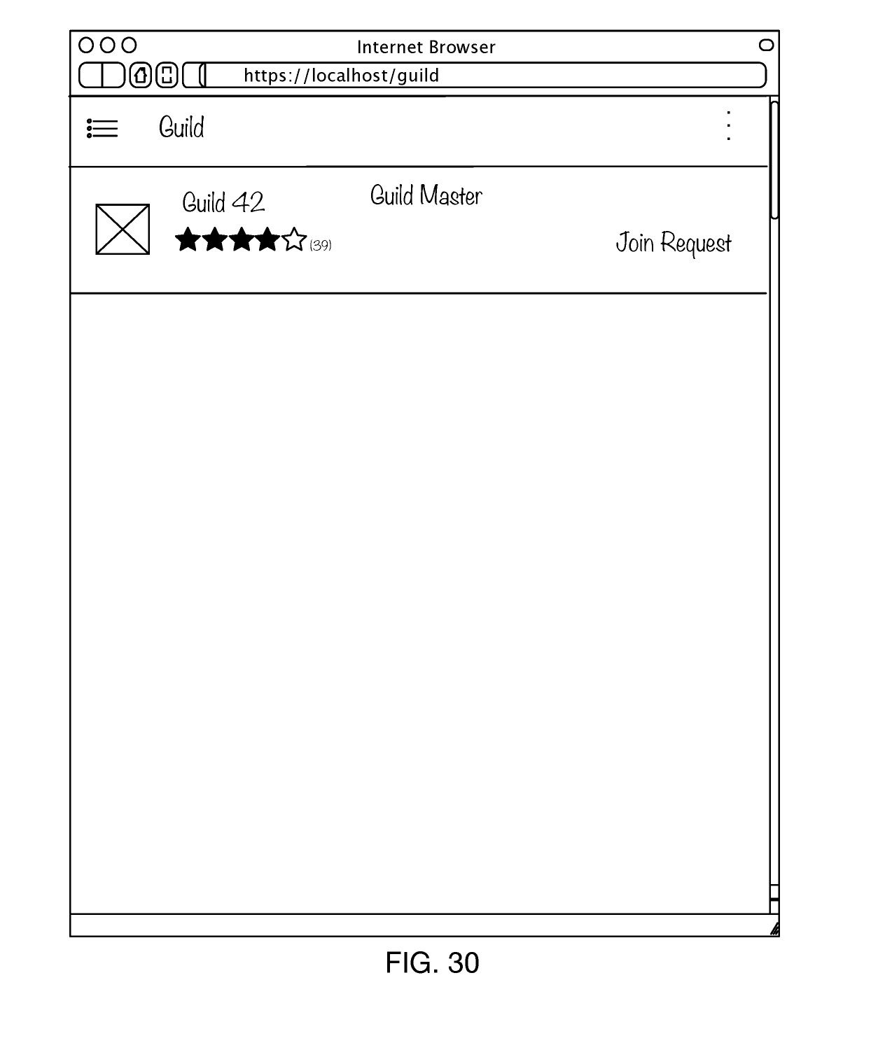

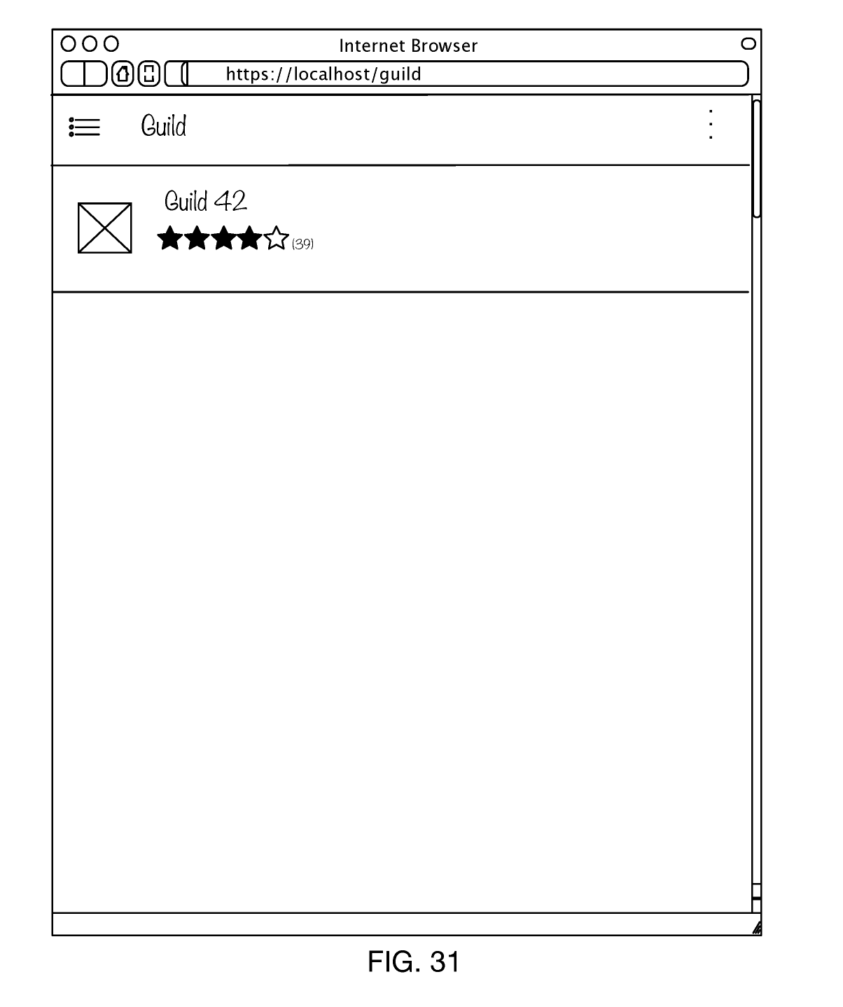

Guilds. Users can also group together to form guilds. A user starts by navigating to the Guild page and if they are not associated with a guild, are given the option to create a guild or join an existing guild as seen in FIG. 29. If a user creates a guild, they become the guild master, if a user joins a guild they become a guild member. A user can be a master or member of multiple guilds and the Guild page will list those associations as seen in FIGS. 30-31. A user's provider skill can only be associated with one guild at a time.

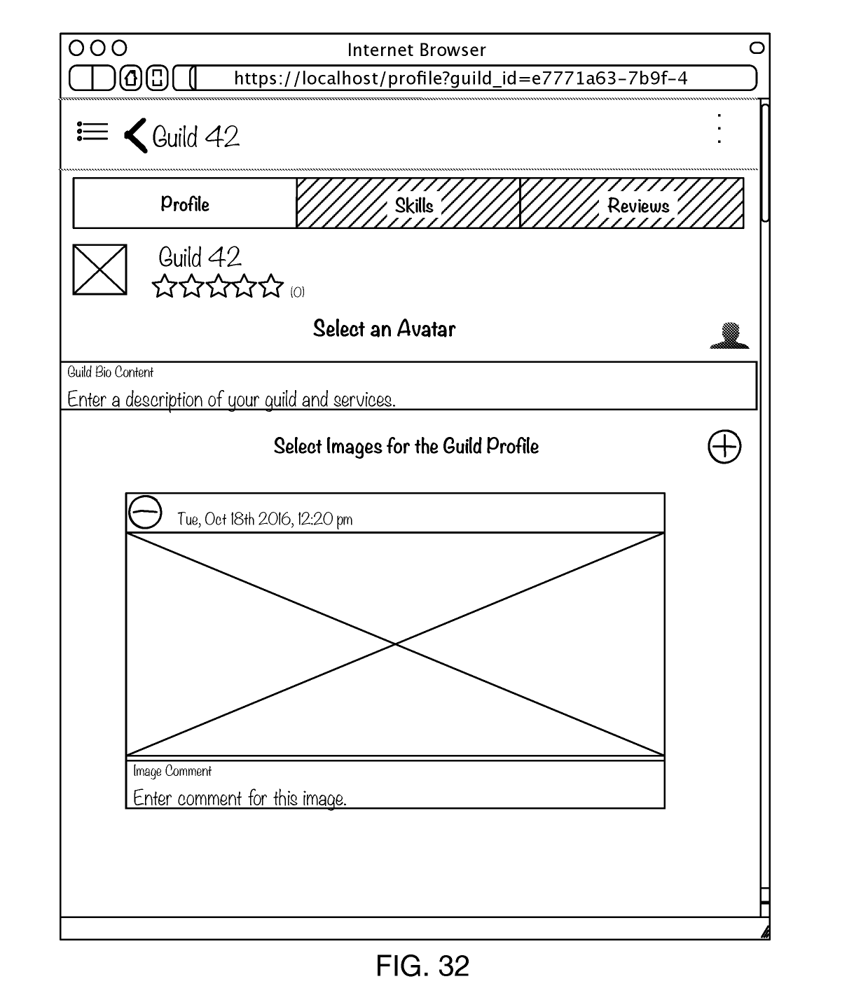

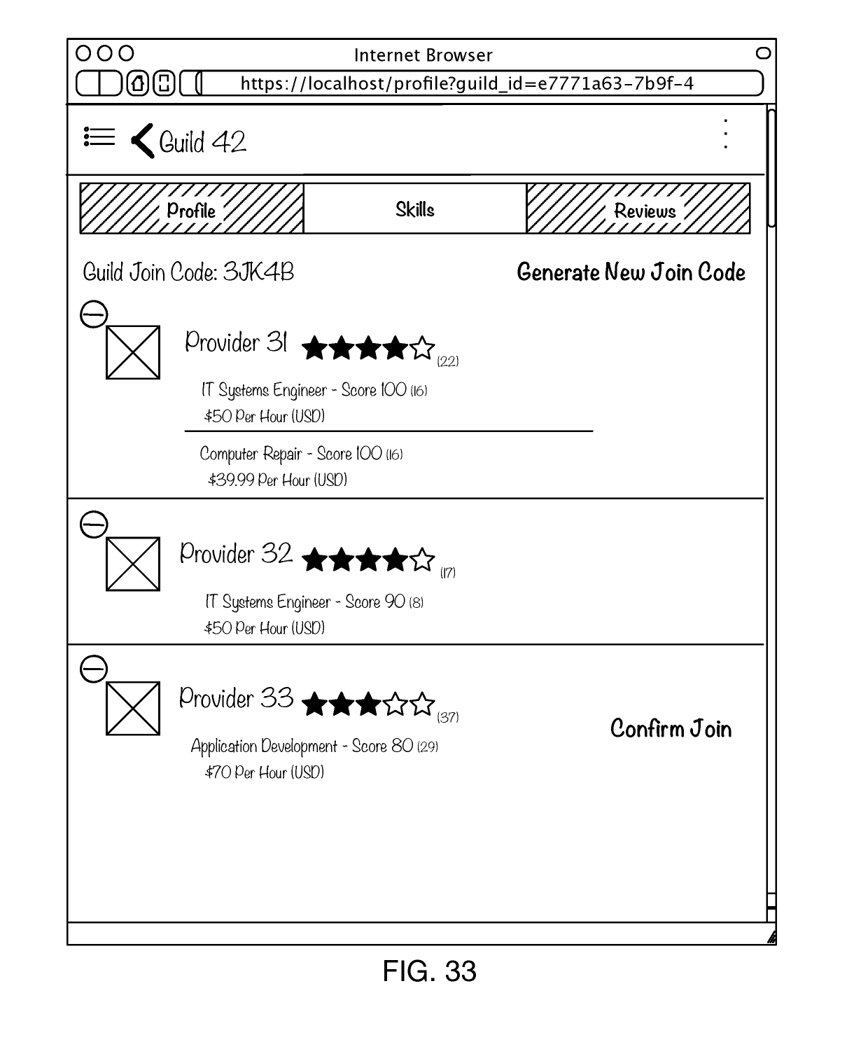

If a user selects create guild, they are prompted to enter a guild name and the system returns a guild join code and navigates to the guild profile page. The Guild Profile page as seen in FIGS. 32-33 allows a guild master to create a profile for the guild that functions like a normal user profile. The guild master can upload a guild profile image, biography, other images and comments, view and map skills, and view the guild's reviews. The skills tab on the Guild Profile page allows the guild master to view provider skills mapped to the guild, map their own provider's skills to the guild, generate a new guild join code, confirm new guild join requests, or delete users from the guild.

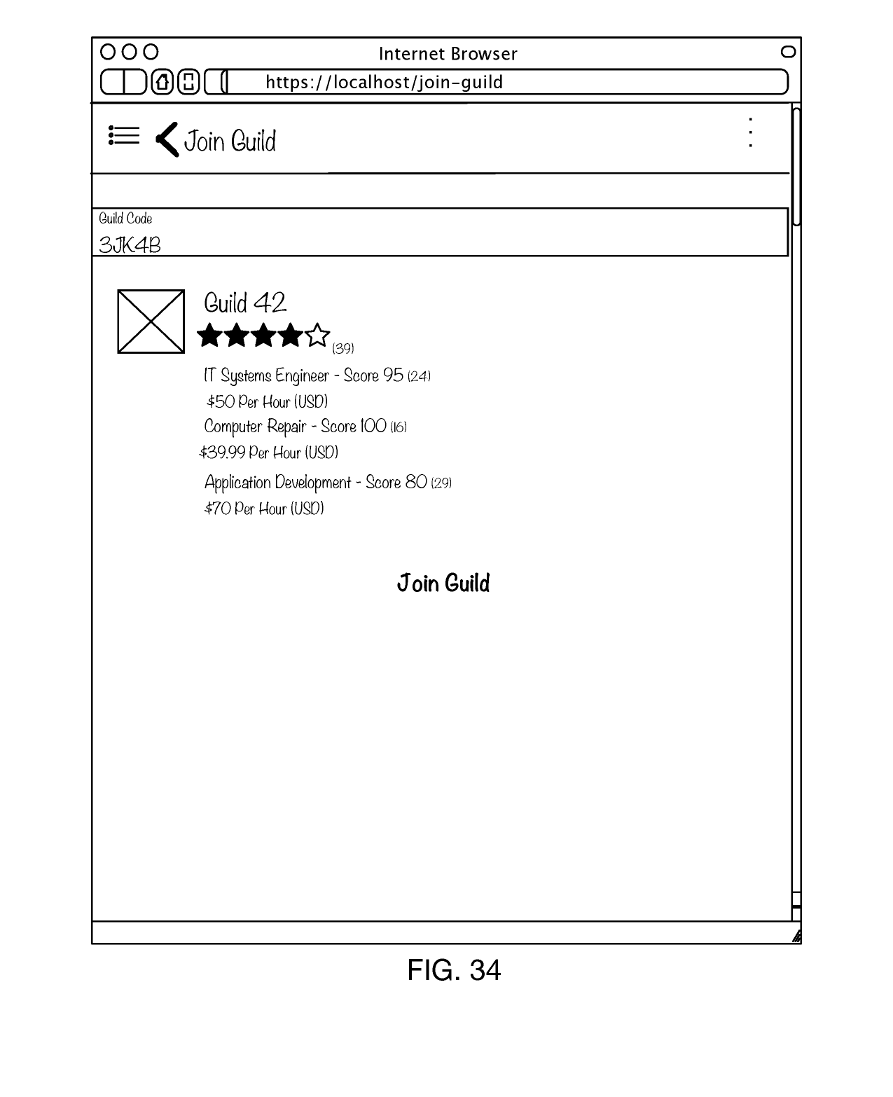

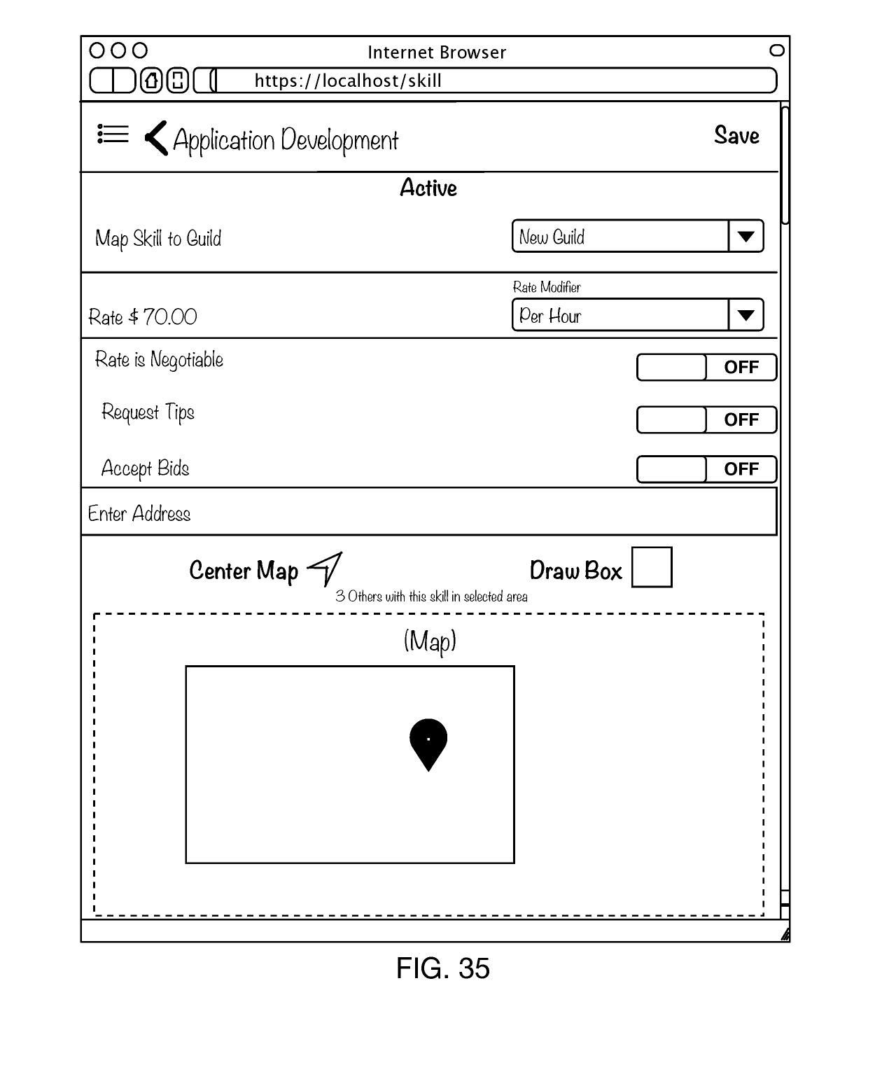

A guild master invites users to join they guild as a member by providing them the guild join code. The user then navigates to the guild page and select join guild. After the user enters the join code in the Join-Guild page as seen in FIG. 34 the page updates with guild information such as the name, karma rating, and skills it's existing members have mapped to the guild. Selecting Join Guild will send a notification to the guild master and put the member's status into pending. Once the guild master has confirmed the users join request, the user becomes a member of the guild. The member can now navigate to their user profile page and select one of their existing skills to map to the guild. Guild members have drop down list at the top of their skill page which provides a list of all the guilds they are currently associated with as seen in FIG. 35. Using this selection, they can map their skill to a guild.

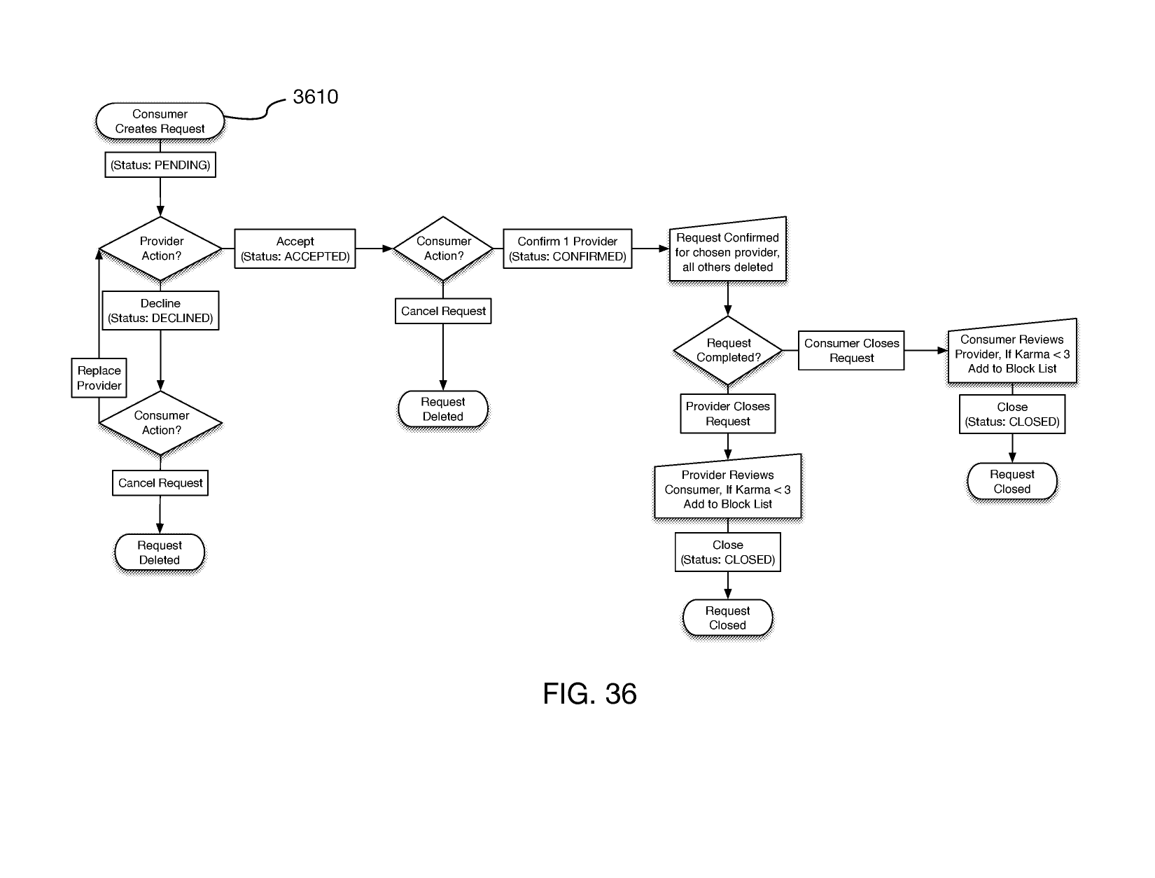

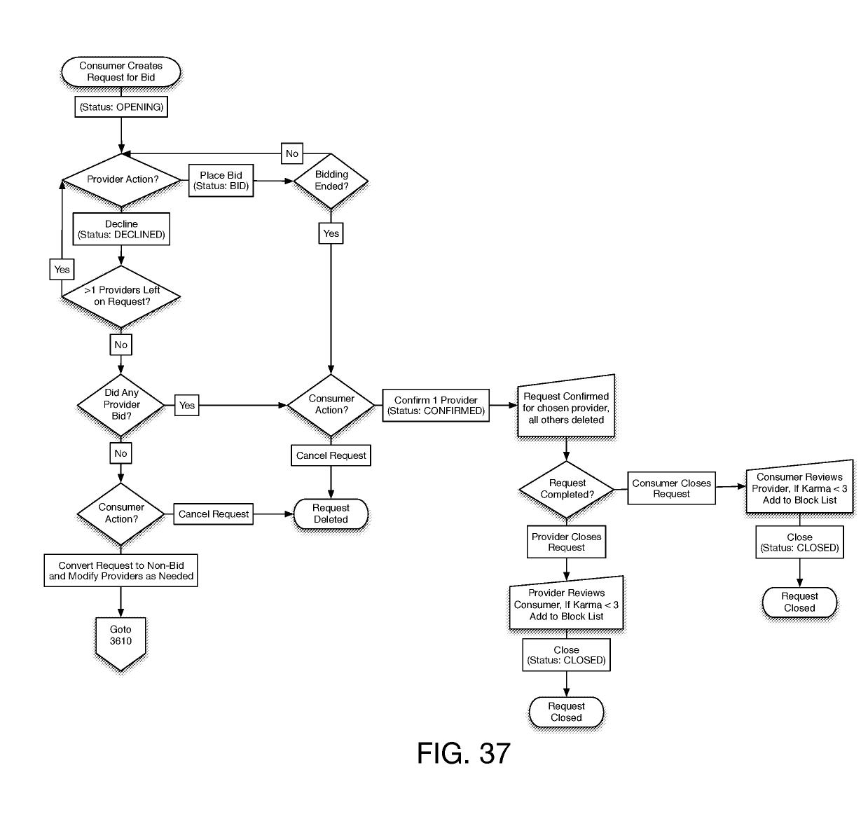

FIG. 36 is a flow chart of the procedure and status associated with a typical non-bid request. FIG. 37 is a flow chart of the procedure and status associated with a typical bid request. Depending on events that transpire, the flow may transfer back to FIG. 36. In the course of a request's lifecycle, it's status may change depending on the actions of the consumer and the provider. Valid request status may include, but are not limited to: Opening, Pending, Bid, Accepted, Declined, Confirmed, and Closed. FIGS. 36-37 depict the lifecycle of a request in relation to these status.

It is noted that the examples shown and described are provided for purposes of illustration and are not intended to be limiting. Still other examples are also contemplated.

1. A skill sharing platform comprising:
a computer store including data defining a plurality of skill profiles;
wherein each of the skill profiles corresponds to a service provider offering services;
wherein each of the skill profiles corresponds to defined geospatial service areas;
a computer server coupled to the computer store and programmed to:
receive a request from a consumer;
identify a requested skill profile based on input received from a consumer in the request;
provide the requested skill profile to the consumer using the skill sharing platform in a defined geospatial service area;
determine at least one of a score and a karma based on interaction between the service provider and the consumer; and
wherein the score and the karma are automatically applied by the computer server to ones of the skill profiles corresponding to the service provider stored in the computer store, and the score and karma automatically retrieved by the computer server and displayed with the skill profiles in response to future requests by other consumers to influence the other consumers' decisions to generate a request for services.

2. The skill sharing platform of claim 1, wherein the score indicates a service provider's proficiency in a skill.

3. The skill sharing platform of claim 1, wherein the karma indicates a service provider's rating as a person.

4. The skill sharing platform of claim 1, wherein the one or multiple service providers are attached to the requested skill profile.

5. The skill sharing platform of claim 4, wherein in the case of multiple service providers, each of the multiple service providers is provided an option to bid against other of the multiple service providers for acceptance of the request from the consumer.

6. The skill sharing platform of claim 1, wherein one or more parameter of the request from the consumer is negotiable.

7. The skill sharing platform of claim 1, wherein when an existing request from the consumer is modified, all associated service providers associated with the existing request are notified of the modification to the existing request.

8. The skill sharing platform of claim 1, wherein a parameter of the request from the consumer cannot be modified after the request has been accepted by the consumer making the request.

9. The skill sharing platform of claim 1, wherein upon completion of the request from the consumer by the service provider, the consumer is required to rate their experience.

10. The skill sharing platform of claim 9, wherein rating by the consumer is used to generate the score and the karma.

11. The skill sharing platform of claim 10, wherein when a service provider's score and/or karma fall below a threshold, the skill profile of the service provider is penalized.

12. The skill sharing platform of claim 11, wherein the service provider is added to a block list so that the skill profile of the service provider is blocked from the consumer making the request for all future requests by the consumer when the service provider's score and/or karma has fallen below the threshold.

13. The skill sharing platform of claim 12, wherein the block list is editable by the consumer to add and remove service providers from the block list.

14. The skill sharing platform of claim 12, wherein the consumer can issue the block list to another consumer.

15. The skill sharing platform of claim 1, further comprising the computer server generating a skill profile for a guild.

16. The skill sharing platform of claim 15, wherein a skill profile for the guild has a guild score and a guild karma.

17. The skill sharing platform of claim 1, wherein skill names for skill profiles are user-generated.

18. The skill sharing platform of claim 1, wherein service providers map their account to a skill name for their skill profile.

19. The skill sharing platform of claim 1, wherein a service provider defines a geospatial polygon on a skill map to identify whether their skill profile is viewable in search results based on geospatial data of the consumer

20. The skill sharing platform of claim 1, wherein a provider can enable or disable a skill map to control whether their skill profile is viewable in search results provided to the consumer.
